(19) United States
(12) Patent Application Publication
(10) Pub. No.: US 2023/0251236 A1
(43) Pub. Date: Aug. 10, 2023

(54) TITRATION-GAS CHROMATOGRAPHY METHOD AND SYSTEM FOR ANODE DETECTION AND QUANTIFICATION IN ENERGY STORAGE DEVICES

(71) Applicant: The Regents of the University of California, Oakland, CA (US)

(72) Inventors: Ying Shirley Meng, San Diego, CA (US); Chengcheng Fang, La Jolla, CA (US); Wurigumula Bao, La Jolla, CA (US); Xuefeng Wang, La Jolla, CA (US)

(21) Appl. No.: 18/167,026

(22) Filed: Feb. 9, 2023

Related U.S. Application Data
(60) Provisional application No. 63/267,781, filed on Feb. 9, 2022.

(51) Int. Cl. G01N 31/16; G01N 30/16

(52) U.S. Cl. CPC G01N 31/16; G01N 30/16; G01N 2030/025

(57) ABSTRACT

Disclosed are methods and systems for the use of titration-gas chromatography (TGC) to differentiate and quantify metallic substances (M⁰) and ionic metal (Mn⁺) in an anode material, such as in rechargeable-battery anodes of metal type (e.g., Li, Na, K, Mg, Ca, Fe, Zn, Al, etc.) or compound type (e.g., LiₓC6, LiₓSi, LixSn, etc) by using the proper titrant.

### CROSS-REFERENCE TO RELATED APPLICATION

This application claims the benefit of U.S. Provisional Patent Application No. 63/267,781, entitled “TITRATION-GAS CHROMATOGRAPHY METHOD AND SYSTEM FOR ANODE DETECTION AND QUANTIFICATION IN ENERGY STORAGE DEVICES,” filed on Feb. 9, 2022, which is incorporated herein by reference in its entirety.

### STATEMENT REGARDING FEDERALLY SPONSORED RESEARCH OR DEVELOPMENT

This invention was made with government support under DE-EE0007764 awarded by the Department of Energy. The government has certain rights in the invention.

### TECHNICAL FIELD

This patent document relates to energy storage technologies.

### BACKGROUND

Rechargeable lithium-ion batteries (LIBs) are widely used in portable consumer electronics and electric vehicles and show great promise in large-scale grid energy storage. LIBs with high energy density, long cycle life, and low cost have been the main driving forces for developing new electrode materials. What is needed are new materials and anode configurations for improving durability for energy storage devices.

### SUMMARY

Disclosed are methods and systems, which among other features and benefits, enable the use of titration-gas chromatography (TGC) to differentiate and quantify metallic substances (M⁰) and ionic metal (Mn⁺) in rechargeable-battery anodes of metal type (e.g., Li, Na, K, Mg, Ca, Fe, Zn, Al, etc.) or compound type (e.g., LiₓC6, LiₓSi, LixSn, etc.) by using the proper titrant. The disclosed TGC methodologies are based on the different reaction products of M⁰ and Mn⁺ with the titrant to realize the differentiation and quantification.

### BRIEF DESCRIPTION OF THE DRAWINGS

This application contains at least one drawing executed in color. Copies of this application with color drawing(s) will be provided by the Office upon request and payment of the necessary fees.

FIG. 1 shows a schematic illustration of an example embodiment of a TGC system in accordance with the present technology.

FIG. 2 shows a flow diagram illustrating an example TGC method for anode detection and quantification in energy storage devices.

FIG. 3 shows data plots exhibiting example data from example implementations of an example embodiment of the TGC method.

FIG. 4 shows data plots exhibiting example data from example implementations of an example embodiment of the TGC method.

FIG. 5 shows data plots exhibiting example data from example implementations of an example embodiment of the TGC method.

FIG. 6 shows data plots exhibiting example data from example implementations of an example embodiment of the TGC method.

FIG. 7 shows a data plot exhibiting example data from example implementations of an example embodiment of the TGC method.

FIG. 8 shows a schematic of two types of active lithium loss in silicon anode in (a) SEI formation (b) Trapped Li—Si alloy.

FIGS. 9a-d show a TGC solvent screening for Si anode (a) Schematic of TGC workflow conducted on silicon thin film. Titration solvent selection for TGC measurements of (b) lithiated Si thin film, (c) Nano-Si, and (d) Nano-Si+LiF.

FIG. 10 shows Li quantification in Si anode at the first cycle with charge and discharge profiles of Si thin film and TGC results of (a) lithiation process with different cut-off voltage; (b) delithiation process with different cut-off capacities. PL refers to the point of lithiation, and PD refers to the point of delithiation.

FIGS. 11a-f show nanostructures of trapped Li—Si alloy in Si thin film anode after the first cycle by cryo-TEM; (a, d) TEM images for (a) pristine and (d) cycled Si thin film anode samples. HRTEM images of (b) pristine and (c) cycled Si thin film electrode and (c, f) SAED patterns corresponding to (b) and (e).

FIGS. 12a-d show Li quantification in Si anode at following cycles; (a) Charge/discharge voltage profiles and (b) cycling performance of Si thin film in half-cell. (c) TGC results of Si thin film at different cycles. (d) EIS Nyquist plots of Si thin film half-cell at different cycles.

FIG. 13 shows Cryo-FIB-SEM for cross-section and top view surfaces of Si thin film electrode; (a) pristine, (b) after 1 cycle, (c) after 10 cycles, and (d) after 30 cycles.

FIG. 14 shows cycling performance with different upper cut-off voltages; (a) Charge/discharge voltage profiles and (b) cycle performance of Si thin film at voltage range of 0.01 V-0.6 V, 0.01 V-0.8 V, and 0.01 V-1.5 V.

FIG. 15 shows SEM images of Si thin film: (a) Surface, (b) cross-section.

FIG. 16 shows a table illustrating H₂ concentration in the blank samples measured for LOD/LOQ analysis.

FIG. 17 shows an H₂ calibration curve (a) H₂ concentration in ppm calibration curve as a function of detected H₂ area; (b) related Li amount in mol as a function of detected H₂ area.

FIG. 18 shows a titration solvent selection for TGC measurements, TGC results of Si thin film and Nano Si powder with DI-H₂O.

FIG. 19 SEI component characterization through XPS analysis on lithiated Si thin film sample.

FIG. 20 shows a table including the solubility or reactivity of known SEI component with ethanol and water.

FIG. 21 shows SEI component characterization by XPS on de-lithiated Si thin film.

FIG. 22 shows a table Lithium tracking in Si thin film electrode during TGC experiment.

FIG. 23 shows a table with Si thin film electrode sample information for TGC experiment.

FIG. 24 shows STEM/EDS for Pristine and cycled Si thin film anode under cryo condition. (a, d) TEM images for (a) pristine and (d) Si thin film anode after the first cycle. HAADF images and elemental distribution of highlighted region in (a) green square and (b) orange square for (b, c) pristine and (e, f) Si thin film anode after the first cycle.

FIG. 25 TGC results of the SEI and trapped Li—Si alloy after 30 cycles with delithiation cut-off voltage 1.5 V and 0.6 V.

FIG. 26 shows quantitative differentiation of inactive Li by the TGC method.

FIG. 27 shows microstructures of inactive Li generated in HCE and CCE imaged by cryo-FIB-SEM.

FIG. 28 shows nanostructures of inactive Li generated in HCE and CCE imaged by cryo-TEM.

FIG. 29 shows a schematic of inactive Li formation mechanism in different electrolytes, based on TGC quantification, cryo-FIB-SEM and cryo-TEM observation.

FIG. 30 shows schematic working principle of the TGC method.

FIG. 31 shows data for TGC materials for Li∥Cu cells

FIG. 32 shows results for TGC analysis of inactive Li formed under extended electrochemical conditions.

FIG. 33 shows XPS analysis of inactive Li SEI components formed in HCE and CCE for various stripping rates.

FIG. 34 shows data for cryo-FIB-SEM and cryo-TEM analysis.

FIG. 35 shows data for strategies that may mitigate inactive Li formation.

FIG. 36 shows data for TGC calibration and LOD/LOQ analysis.

FIG. 37 shows data for GC chromatogram and N₂ interference analysis.

FIG. 38 shows data for analysis of possible LiH presence in inactive Li.

FIG. 39 shows a table including data for the solubility or reactivity of known SEI species with H₂O.

FIG. 40 shows Challenges of pSi anode for LIBs.

FIG. 41 shows (a) SEM cross-section images of points of lithiation: PL4, PL6, PL8, PL10 (b) First lithiation process in μSi electrode from half-cell; inset: related TGC Data (c) First cycle voltage profile of μSi electrode with different lithiation capacities; inset: related TGC result after de-lithiation.

FIG. 42 shows (a) a cycle performance of CMC-Na and PAA half cells: Trapped Li—Si alloy and SEI Li+ from TGC results for total capacity loss from different cycles of (b) CMC-Na and (c) PAA half-cell.

FIG. 43 shows (a) a State of Charge (SoC) v/s N/P ratio plot (b) First Cycle Charge-Discharge profile of pSi-CMC-Na-LFP full cells with various N/P ratios (c) First Cycle Charge-Discharge profile of pSi-PAA-LFP full cells with various N/P ratios.

FIG. 44 shows (a) a Cycle performance of μSi-CMC-Na-LFP full-cell with various N/P ratios (b) Cycle performance of μSi-PAA-LFP full-cell with various N/P ratios (c) TGC Data for Lithium inventory loss of full cell after 1st cycle for various N/P ratios (d) TGC Data for Lithium inventory loss of full cell after 10 cycles for various N/P ratios.

### DETAILED DESCRIPTION

The techniques disclosed herein can be applied to quantitatively detect and “inventory” Li in alloy type, carbon-based, composite and multivalent anodes. In some implementations, for example, the accuracy of the results can be dependent on the type of titrant. Differentiating and quantifying Mn⁺ and M⁰ after cycling is one of the most challenging problems that hinder the understanding of failure mechanisms in high energy density rechargeable batteries, thus obstructing their development for next-generation electric vehicles and other applications. The disclosed TGC methodology can be implemented for differentiating and quantifying M⁰ and Mn⁺.

This patent document includes description of the role of lithium in LIBs as a primary failure product of lithium metal batteries, e.g., showing failures of unreacted metallic lithium rather than the solid electrolyte interface (SEI).

The disclosed TGC detection methods are capable to differentiate and quantify metallic substances (M⁰) and ionic metal (Mⁿ⁺) in the anode with the metal type (Li, Na, K, Mg, Ca, Fe, Zn, Al, etc.) and compound type (lithium-ion battery: LiₓC₆, LiₓSi, LiₓSn, etc.; Na ion battery: hard carbon, etc.) of rechargeable battery by using proper titrant. The methodology is based on the different reaction products of M⁰ and Mⁿ⁺ with the titrant to realize the differentiation and quantification. In rechargeable batteries, during the charging/discharging process an anode with strong reducibility is prone to form surface passivation layers, namely SEI, which contain Mⁿ⁺ when soaking in the electrolyte. Upon the cycling, the side reactions further take place at the anode-electrolyte interface, leading to low Coulombic Efficiency (CE) and capacity loss. Differentiating and quantifying Mⁿ⁺ and M⁰ after cycling is one of the most critical yet challenging problems that hinder the thorough understanding of the failure mechanism and then substantially obstacles the development of high energy density rechargeable batteries for next-generation electric vehicle applications.

The rechargeable batteries, such as lithium-ion batteries, have thriving prospects in the field of energy. The study of active element inventory loss is crucial for understanding the attenuation mechanism of batteries. As for Lithium-ion batteries, the high reactivity of anode materials makes it hard to be characterized. Recently, the Cryogenic TEM technique made it possible to directly visualize the nanostructure for the first time. However, TEM is a localized characterization technique, which is impossible to quantify the global amount of Li inventory in a cycled battery. The TGC method provides a solution enabling the quick measurement of substances (M⁰) content in a cycled battery at the microgram (μg) level for the first time.

The disclosed TGC methodologies are capable to differentiate and quantify metallic substances can provide accuracy in differentiating and quantifying M⁰ and Mⁿ⁺, e.g., in which the level of accuracy can depend on the type of titrant. In some example implementations, this technique was applied to quantitatively detect Li inventory in Li, Si, Gr, and Si/C composite electrodes in lithium-ion batteries with optimized titrants.

For example, in rechargeable batteries, during the charging process, the anode material will be reduced. Meanwhile, SEI layers form on the interface of anode and electrolyte spontaneously. The Coulomb counting only provides the overall energy entering the battery but is unable to differentiate the Mⁿ⁺ forming SEI and reduced M⁰. The TGC methodology is based on the measured resultant gas evolution in anode materials. The reduced M⁰ can react with protic titrant to produce H₂. However, SEI layers are made up of inorganic and organic Mⁿ⁺ compounds, such as MOₓ, M(CO₃)ₓ, MFₓ, MNₓ. These species may also react with protic titrant, but no H₂ gas can be generated. Therefore, the relationship between M⁰ and generated H₂ amount can be established, following the reactions below but not limited to:

2Li+2H⁺→2Li⁺+H₂↑

2LiₓSi+2xH⁺→2xLi⁺+2Si+xH₂↑

2LiₓC+2xH⁺→2xLi⁺+2C+xH₂↑

2LiₓSn+2xH⁺→2xLi⁺+2Sn+xH₂↑

2Na+2H⁺→2Na⁺+H₂↑

2K+2H⁺→2K⁺+H₂↑

Mg+2H⁺→Mg²⁺+H₂↑

Ca+2H⁺→Ca²⁺+H₂↑

Fe+2H⁺→Fe²⁺+H₂↑

Zn+2H⁺→Zn²⁺+H₂↑

2Al+6H⁺→2Al³⁺+3H₂↑

The M⁰ amount thus can be determined by measuring the H₂ amount based on, at least, the above equations, using a Gas Chromatography (GC) equipped with a special H₂ detector. The most advanced GC is capable to measure an H₂ concentration as low as 0.1 ppm. Converting to metal mass in the designed system, the minimum detectable M⁰ is at microgram (μg) level. The measuring limit can be further pushed to nanogram (ng) level by optimizing the experiment set-up. The working flow of TGC methodology is (1) solvent choosing, the chemical properties between sample and titrant need to be checked thoroughly, which directly determines the accuracy of the TGC quantification results; (2) calibration curve setup, establishing calibration curve between active materials and TGC results, verifying the accuracy of TGC results.

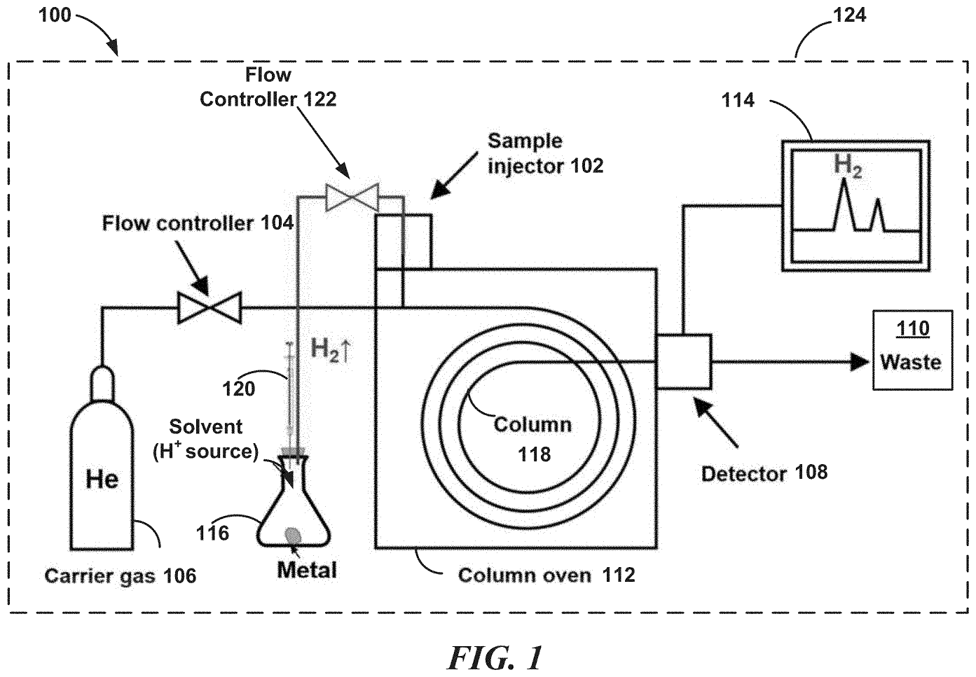

FIG. 1 shows a schematic illustration of an example embodiment of a TGC system 100 in accordance with the present technology. The TGC system 100 includes a sample container 116 (e.g., a flask), a sample injector 102, and a gas-chromatography device including a column 118, a column oven 112, and a detector 108. The system can also include, or be coupled with, an outer container 124, one or more flow controllers (e.g., flow controllers 104 and 122), a waste container 110, and/or a carrier gas source 106. The column 118 fluidically coupled with a carrier gas (e.g., He, N, or Ar) source 106 via a gas line. The flow of the carrier gas from the carrier gas source 106 to the column 118 is controlled by a flow controller 104 coupled to the gas line between the carrier gas source 106 and the column 118. The sample injector 102 is also fluidically coupled to the column 118 and is configured to provide a sample from the sample container 116 to the column 118. The sample container 116 is configured to be sealable to allow reactions between the solvent and the metal sample to occur in an air-tight environment.

For example, a metal sample is inserted into the sample container 116 and an appropriate volume of a solvent is titrated onto the sample container 116 and allowed to react with the metal sample (e.g., through a titration pipette or burette 120). The solvent is configured to operate as H⁺ source (e.g., see the reactions above describing metal and/or metal compound reactions with H⁺). The solvent can include, for example, water, methanol, ethanol, an acid, or any other suitable solvent or a combination thereof. The hydrogen gas released from the reaction between the solvent and the metal and/or metal compound in the sample container 116 is configured to be transported, via a gas line, to the sample injector 102. The flow of the hydrogen sample in the gas line is controlled by the flow controller 122. The sample injector 102 further provides the released hydrogen gas to the column 118.

The column 118 is positioned inside the column oven 112. The column oven 112 can be a packed or a capillary column oven or any suitable column used in chromatographic systems. The column oven 112 is configured to control temperature of the column 118 and the sample received from the sample container 116 from the sample container via the sample injector 102. The column is configured to provide the hydrogen sample (separated from any other gases) together with a carrier gas from the carrier gas source 106 with a controlled flow to the detector 108 (e.g., a GC detector). In some implementations, the detector is a barrier ionization discharge (BID) detector. The detector 108 is configured to detect the amount of hydrogen transported through the column. An exemplary hydrogen peak is illustrated in graph 114 as detected by the detector 108.

The column 118 is further fluidically coupled with the waste container 110. The waste container is configured to receive the gases (e.g., the hydrogen sample and the carrier gas) transported through the column 118 to be disposed of. The system 100 can also include the outer container 124 so that the outer container 124 that is configured to provide a controlled, enclosed environment for the system 100. For example, the outer container 124 is an Ar-filled glovebox. Alternatively or additionally, the system 100 can be operated in a dry room or a dry chamber configured to provide a controlled environment for operating the system 100.

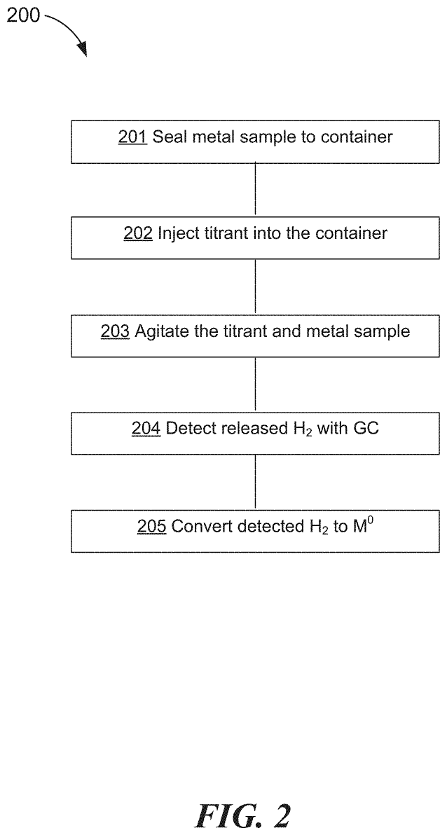

FIG. 2 shows a flow diagram illustrating an example TGC method 200 for anode detection and quantification in energy storage devices. The process flow of the TGC method includes the following processes. At (201), the method 200 includes sealing the metal sample or a metal compound sample into a container (e.g., the sample container 116) in a proper environment (e.g., Ar-filled glovebox/dry room). The metal sample can include metallic substances (M⁰) and ionic metal (Mⁿ⁺) in the anode with the metal type (Li, Na, K, Mg, Ca, Fe, Zn, Al, etc.) and compound type (lithium-ion battery: LiₓC₆, LiₓSi, LiₓSn, etc.; Na ion battery: hard carbon, etc.). Such metals are applicable for rechargeable batteries. The metal sample can further include SEI layers that are made up of inorganic and organic Mⁿ⁺ compounds, such as MOₓ, M(CO₃)ₓ, MFₓ, MNₓ. As explained above, these Mⁿ⁺ compounds may react with titrants but do not generate hydrogen.

In some embodiments, the sample metal includes an alkaline metal anode material (e.g., as described in Example Experiment 1), an alloy type anode (e.g., as described in Example Experiment 2), a carbon-based anode (e.g., as described in Example Experiment 3), a composite anode material (e.g., as described in Example Experiment 4), or a multivalent anode (e.g., as described in Example Experiment 5).

At (202), the method 200 includes injecting a certain amount of titrant (e.g., solvent)(e.g., a protic titrant) into the container to react with the sample (e.g., a metal or metal compound sample). The titrant can include, for example, water, methanol, ethanol, an acid (e.g., acetic acid or sulfuric acid), or any other suitable solvent or a combination thereof. Generally the titrant should be capable of interacting with the metal sample to produce hydrogen, in accordance with the reactions described above. The titrant is significant for the accuracy of differentiating and quantifying the metallic substances (M⁰) and ionic metal (Mⁿ⁺) in the sample metals. For example, the titrant should react with the metallic substance M⁰ to generate H₂ while being chemically inert with other components of the sample. The titrant should be chemically inert with the Mⁿ⁺ components so that no H₂ is generated in the reactions between the Mⁿ⁺ components and the titrant.

At (203), the method 200 includes agitating (e.g., mixing) the titrant and the metal sample well (e.g., by shaking) in the container and connecting the container to the sample injector (e.g., sample injector 102) equipped with a flow controller (e.g., flow controller 122). The flow controller is configured to control the injection of the released hydrogen to a column (e.g., the column 118 in the column oven 112). In some embodiments, a carrier gas is used for assisting the transportation of the hydrogen through the column (e.g., the carrier gas from the carrier gas source 106).

At (204), the method 200 detects released hydrogen using a GC device (e.g., by the detector 108 coupled with the column 118).

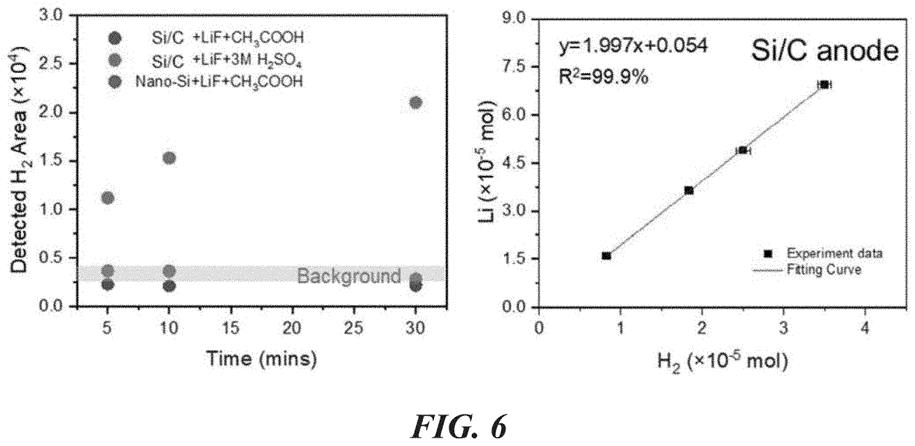

At (205), the method 200 includes converting the detected H₂ amount to M⁰ amount using a pre-established standard calibration curve. For example, FIG. 6 of the Example Experiment 5 illustrates a standard calibration curve and equation of Li in Si/C composite and H₂ amount.

In some embodiments, the Coulomb counting gives the total energy entering a battery. The TGC measurement provides the amount of M⁰. The SEI Mⁿ⁺ can be calculated following relationship:

Coulomb counting (mAh)=Mⁿ⁺(mAh)+M⁰(mAh)

In this way, the ionic metal (Mⁿ⁺) and metallic substances (M⁰) on anode after the charging process are successfully differentiated and quantified by the TGC method. Similarly, after discharging, the residue that includes SEI and SEI wrapped metallic substances on the current collector also can be differentiated and quantified by the same process, following the relationship:

Total capacity loss (mAh)=Mⁿ⁺(mAh)+M⁰(mAh)

Therefore, by comparing the amount of lithium loss caused by different factors, the real reason for capacity attenuation can be found out.

### EXAMPLE IMPLEMENTATIONS

### Example Experiment 1: Alkaline Metal Anode

Li metal anode is the Li metal plating/stripping process profoundly influenced by electrolyte properties and current density. Two types of electrolytes (the Bisalt and the EC/EMC) and two current densities (0.5 and 2.5 mA/cm²) have been studied to investigate the “dead Li” compositions and the correlation with CE using the TGC method. “Dead Li” is the residue that includes SEI and SEI wrapped Li⁰ on the Cu foil after plating and stripping cycles. The SEI Li⁺ is irreversible capacity loss. The “dead” Li⁰ is metallic Li that is wrapped by SEI and thus loses contact with the current collector. The “dead” Li⁰ may be converted to active Li⁰ under certain conditions. This is the reason why the “dead Li” quantification is a critical problem in the field. The TGC method can differentiate and quantify the amount of Li⁰ and SEI Li⁺ by using H₂O as the titrant, because only Li⁰ can react with H₂O and produce H₂(2Li+2H₂O=2LiOH+H₂), while SEI Li⁺ cannot.

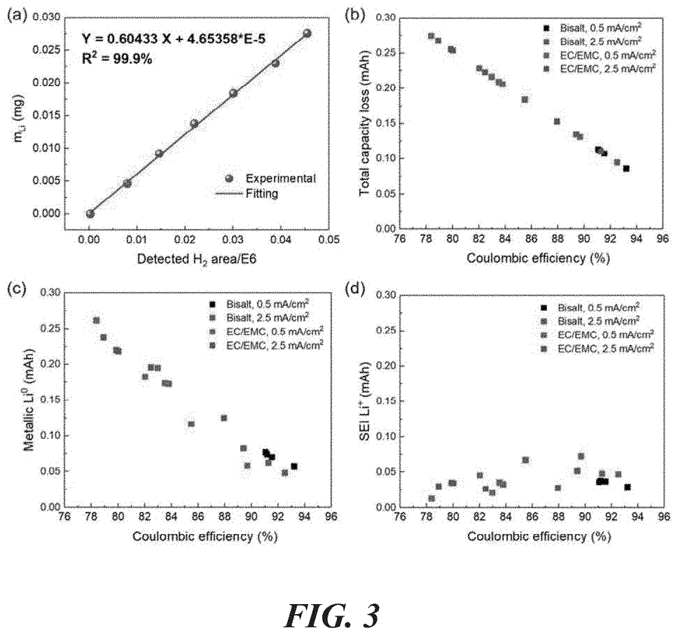

FIG. 3 shows data plots exhibiting example data, including (a) standard calibration curve and equation; (b) the total capacity loss (total “dead Li” amount) of samples; (c) measured metallic Li⁰ amount of samples using TGC method; (d) calculated SEI Li⁺ amount based on total capacity loss and measured metallic Li⁰. FIG. 3a shows the as-established standard calibration curve and equation, converting the detected H₂ amount to “dead” Li⁰ amount. FIG. 3b shows the CE of samples tested under different conditions as a function of total capacity loss. The total capacity loss is calculated after the first plating and stripping process in a Li—Cu cell. Following the above detailed TGC method, the metallic Li⁰ is measured for each sample. FIG. 3c shows the relationship between CE and the measured Li⁰ content. FIG. 3d is the calculated SEI Li⁺ amount. Regardless of different testing conditions, the more Li⁰ in the “dead Li”, the lower CE is. It is clear to see the “dead” Li⁰ contributes most of the capacity loss. In the Bisalt electrolyte, the percentage of metallic Li⁰ in “dead Li” is 66.5% and 55.5% at 0.5 and 2.5 mA/cm², respectively. The number in the EC/EMC electrolyte is as high as ˜85%. As there are no existing methods to detect the “dead” Li⁰ content, it is generally believed in the literature that the capacity loss is mainly due to the repeated formation of SEI. The influence of “dead” Li⁰ is highly underestimated. The TGC method opens the possibility of differentiating the “dead Li” and provides clear evidence that the “dead” metallic Li⁰ is the major contributor to capacity loss. In addition, the TGC method is applicable to other alkaline metal anodes such as sodium and potassium which are promising candidates for energy storage devices.

### Example Experiment 2: Alloy Type Anode

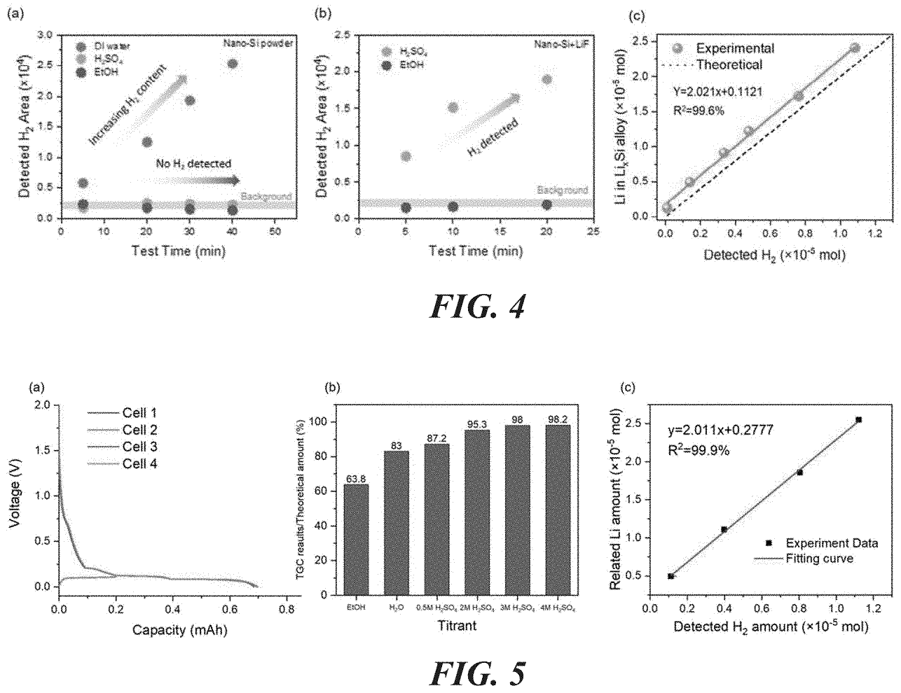

FIG. 4 shows data plots depicting a titration solvent selection for TGC measurements of (a) Nano-Si, and (b) Nano-Si+LiF; (c) standard calibration curve and equation of Li in LiₓSi and H₂ amount.

Silicon anode suffers severe volume change during the cycling. This mechanical deformation usually results in more silicon surface exposure to the liquid electrolyte, wherein side reactions lead to forming more SEI species and causing Li loss. To develop the TGC method for Li quantification in Li—Si alloy, we firstly explored the reaction mechanisms between Li—Si alloy and protic solutions. The chemical reaction formula is shown as follows, 2LiₓSi+2xH⁺=2xLi⁺+2Si+xH₂. Since H₂O can react with Si to generate H₂, excess H₂ amount was detected when using H₂O as the titrant, while H₂SO₄ and C₂H₅OH(EtOH) are stable with Si, as shown in FIG. 4a. In addition to Li—Si alloys, the solubility and reactivity of SEI components in the two titrants also need to be considered. Most of the SEI components are stable with selected titrants except for LiF. FIG. 4b shows that nano-Si mixed with LiF will react and generate H₂ when H₂SO₄ titrant is used due to the HF formation from LiF in acidic environments, which further reacts with Si to yield H₂. Neither H₂O nor H₂SO₄ solution is suitable for TGC experiments on the quantification of Li in Li—Si alloy. EtOH as a mild protic solvent is chemically stable with Si SEI components. At the same time, EtOH can react with Li—Si alloy to generate H₂ for Li quantification. Therefore, it is chosen as the solvent for the TGC study. FIG. 4c shows the as-established standard calibration curve and equation, converting the detected H₂ amount to Li—Si alloy amount in the electrode. The TGC method offers a new framework for the quantitative study of lithium loss in Si anodes, especially after different cycles or with different cycling conditions (e.g., different electrolytes, binder, carbon additive, etc.).

### Example Experiment 3: Carbon-Based Anode

Based on the Si anode study, we noticed that proper titrant determines the accuracy of TGC results. The suitable titrant selection needs to meet 1) Only reacting with metallic substance M⁰ to generate H₂ gas and chemically inert with other components; 2) chemically inert with the Mⁿ⁺ components, with no H₂ generation.

Graphite is the most common anode material in commercial lithium-ion batteries. The charging product LiₓC₆ is reductive and can react with protic titrant to produce H₂. Therefore, the TGC method can quantify Li inventory in the graphite anode, following the reaction 2LiₓC₆+2x=2xLi⁺+12C+xH₂. Developing the TGC method for Li quantification in LiₓC₆ is like that of Silicon anode. The reaction mechanism between LiₓC₆ and protic solution should be checked in prior. Graphite is stable with most of the alkaline and acidic solution. Then it is expected that no extra H₂ will be generated.

FIG. 5 shows data plots depicting (a) Charge and discharge profile of graphite anode in half cell; (b) The relationship between different titrants and titration amount; (c) standard calibration curve and equation Li in LiₓC₆ and H₂ amount.

Half cells were fully lithiated and then delithiated with controlled capacity, as shown in FIG. 5a. The cells were disassembled, the graphite electrodes with different amounts of Li inventory were collected. Different protic solvents were applied for the titration, and the results are shown in FIG. 5b. EtOH and H₂O would only titrate 64% and 83% of the remaining capacity, respectively, indicating that the reactivity of LiₓC₆ is not worse than Li metal and Si. Further increasing the concentration of proton may facilitate the reaction. Sulfuric acid with different concentrations has been tried out. A more reasonable ratio was obtained, as shown in FIG. 4b. The higher concentration of the acid, the more accurate results we could get from TGC. Thus, acid is necessary to titrate remained Li—C/Li in the graphite anode.

### Example Experiment 4: Composite Anode

With the increasing demand for high energy density. More and more composite materials are applied in lithium-ion batteries. Among them, Silicon/carbon (Si/C) composite is one of the choices. Based on the previous study for Si anode, ethanol is the most suitable solvent, and sulfuric acid is not stable with Si at the presence of LiF, while acid is necessary to titrate remained Li in the graphite anode. Thus, for the Si/C composite, an investigation was performed to investigate a new solvent for TGC quantification. The ideal titrant should be no OH⁻ since it can react with Si and generate excess H₂. The titrant should be acidic, and the acidity should be less than HF to prevent the reaction between Si and HF. Based on the acid dissociation constant, the acetic acid meets all the requirements.

FIG. 6 shows data plots depicting (a) Titration solvent selection for Si/C composite; (b) standard calibration curve and equation of Li in Si/C composite and H₂ amount. In FIG. 6a, the stability of the Nano-Si/graphite composite with LiF in acetic acid solution is checked. FIG. 6a shows that the composite is not stable with H₂SO₄ when LiF presented, while no H₂ can be detected if H₂SO₄ is replaced by acetic acid. Therefore, acetic acid is a potential titrant candidate for the composite anode. The relation between the remaining active Lithium in composite anode and generated H₂ amount is checked, and the results are shown in FIG. 6b. The detected H₂ amount from the TGC method matched well with the Li amount calculated by the capacity from the cycler. It shows a linear relation with 2 as the slope. The results indicate acetic acid as the titrant can be applied to Si/C composite anode for TGC quantification. All these data prove the feasibility of TGC method to quantify the remaining capacity on the anode side.

### Example Experiment 5: Multivalent Anode

Next-generation batteries have been explored for their unique merits, including safe operation, non-toxicity, environmentally friendly materials, and earth abundance. Among them, multivalent ions, such as Al³⁺, Zn²⁺, Ca²⁺, and Mg²⁺, are widely studied chemistries as alternatives to Lithium-ion chemistry. All the reduced anode can react with protic titrant to produce H₂, and TGC can be applied for quantification.

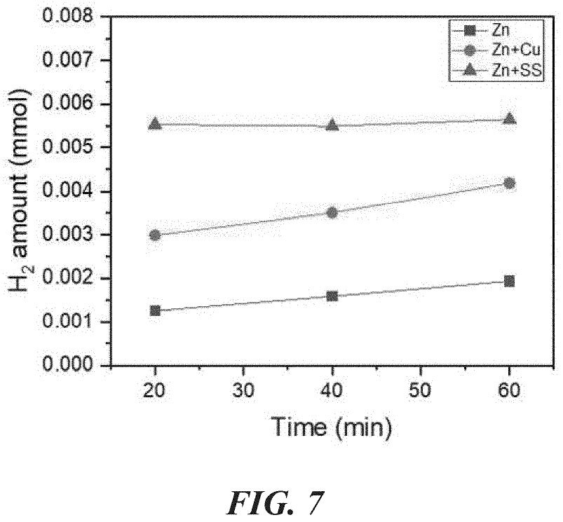

FIG. 7 shows a data plot depicting example data of the gassing speed of current collector in Zn battery, Cu: copper, SS: stainless steel. In the example implementations associated with FIG. 7, we studied the gassing effect in Zn battery with different current collectors. Aqueous zinc batteries (aqZBs) are promising energy storage systems because of their low cost, environmentally benign, resource abundance, and high capacity (820 mAh g⁻¹).

Additionally, given the higher ionic conductivities of aqueous electrolytes (≈100 mS·cm⁻¹ for aqZBs), it demonstrates superior performances in high current applications in high power electronics. However, the instability and corrosion of the Zn anode in basic electrolytes is one of the reasons to hinder its cyclability and shelf life, in which the current collector corrosion facilitates Zn anode corrosion and result in gassing and hydrogen evolution reactions (Zn+H₂O=ZnO+H₂, Zn+2H₂O=Zn(OH)₂+H₂). Therefore, it is essential to study the effects of the current collector metal with the amount of H₂ gassing in an aqueous electrolyte. The amount of H₂ and its evolution over time can be quantified and monitored by the TGC method. The corrosion amount and rate of different current collectors can be revealed.

In the example implementations to obtain the data of FIG. 6, we used basic aqueous electrolyte as the titrant, compared the H₂ evolution of copper (Cu) and stainless steel (SS) in contact with Zn to probe the H₂ gassing rate in the electrolyte. The results confirmed that SS gasses more than Cu. Cu is a better choice as the current collector than SS. Besides the electrolyte corrosion, the active Zn loss in the Zn battery can be quantified by TGC as well by changing the titrant to an acidic solution. The TGC method provides a quantitative approach to investigate Zn battery's capacity loss, corrosion, and shelf life with different strategies (e.g., different electrolytes, electrode composition and morphology, current collector, etc.). This study demonstrates the extensibility of the TGC methodology, providing an in-depth understanding of multivalent-based energy storage devices.

The following examples further illustrate the above described embodiments and examples of the present technologies. These examples are intended merely to be illustrative of the present described technologies and are not to be construed as being limiting.

Quantifying Lithium Loss in Amorphous Silicon Thin Film

Silicon with a high theoretical capacity (3579 mAh/g) is a promising anode candidate for lithium-ion batteries. However, the commercialization is still impeded by low CE, caused by SEI formation and trapped Li—Si alloy during repeated volume change. Quantifying capacity losses from each factor is crucial to formulate rational design strategies for further improvement. In this work, TGC and cryogenic transmission electron microscopy are applied to characterize the evolution of trapped Li—Si alloy and SEI growth in a silicon thin film anode. It is found that the continuous growth of SEI is the dominant factor for Li inventory loss during the cycling, with only a marginal increase in trapped Li—Si alloy. This study offers a quantitative approach to differentiate Li in SEI from trapped Li in Li—Si alloy through a silicon thin film anode, providing unique insights into identifying the critical bottlenecks for developing silicon anode.

Rechargeable LIBs are widely used in portable consumer electronics and electric vehicles and show great promise in large-scale grid energy storage. LIBs with high energy density, long cycle life, and low cost have been the main driving forces for developing new electrode materials. Silicon (Si) is a promising candidate for next-generation LIB anode material due to its high specific capacity (Li3.75Si, 3579 mAh/g), low alloying potential (0.4 V vs. Li⁺/Li), and relatively high abundance in the earth crust. However, silicon suffers severe volume expansion during the electrochemical lithiation process. This mechanical deformation usually results in more silicon surface exposure to the liquid electrolyte, where side reactions occur to form excess SEI with Li inventory loss. Extensive studies have proposed that SEI properties have a critical impact on silicon anode's cycling performance. On the one hand, it is believed that inorganic SEI species, such as LiF and Li2O contribute to better cycling stability because the ionic bonds can facilitate hopping-type transport. Inorganic SEI components can also adapt to the plastic deformation caused by volume expansion due to their high Young's modulus and high interfacial energy (low adhesion) with lithium silicon alloy. On the other hand, the silicon SEI is a group of lithium compounds, including Li₂CO3, LiF, Li₂O, LixSiOy, dilithium ethylene glycol dicarbonate (Li₂EDC), and ROLi (where R depends on the solvent). The excess formation of Li-containing SEI species consumes limited active Li-ions in a full cell, reducing the reversible capacity during cycling.

Multiscale characterizations have been employed to probe the continuous SEI growth for Si anode. Also, in-situ neutron reflectometry (NR) has been applied to identify SEI thickness on Si thin film anode, revealing that upon lithiation the SEI thickening and with delithiation the SEI become thinning. Atomic force microscopy (AFM) findings suggest that the SEI grows thicker upon lithiation and the thickness is reduced during delithiation. Tip-Enhanced Raman Spectroscopy (TERS) and scanning spreading resistance microscopy (SSRM) have been applied to demonstrate that SEI chemical properties changed during cycling due to the significant volume expansion. Qualitative analysis has been carried out on studying silicon SEI's dynamic nature, while quantitative understanding of SEI growth during cycling and its correlation to Li loss remained unclear.

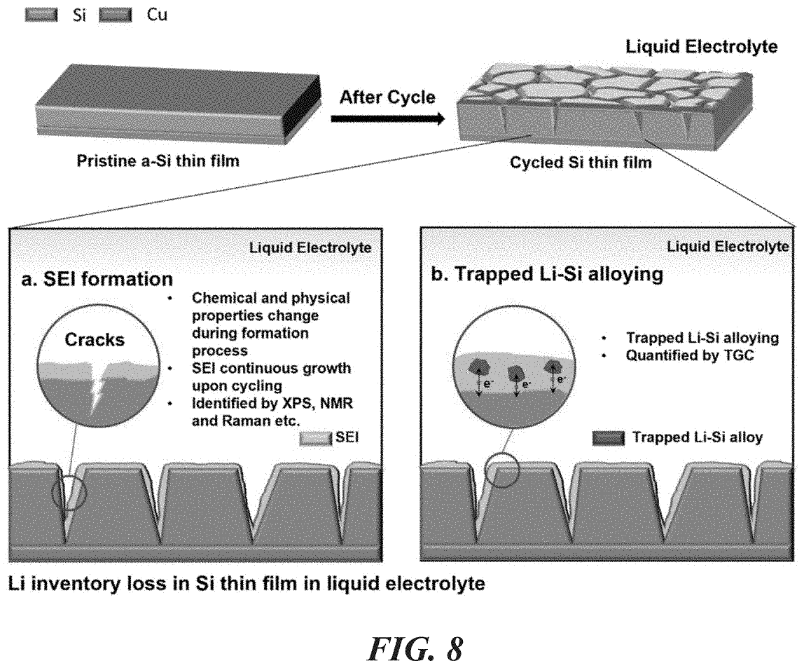

Besides the fact that volume expansion cannot only introduce excess SEI formation but also leads to the loss of electrical contact between the active materials and the conducting network. Additionally, the growth of SEI and the increase of electrode tortuosity during the cycling would block the diffusion of Li-ions and the electron conduction channels. As a result, part of the lithium is irreversibly trapped within the silicon electrode. However, the lack of proper characterizations retarded the quantification of remained lithium in silicon anode. Two types of lithium inventory loss are shown in FIG. 8: the continuous formation of SEI during cycling and the trapped Li in Li—Si alloy due to the kinetic hindrance. Quantifying the lithium loss caused by different reasons is thus the key to elucidate the degradation mechanism of silicon anode.

Herein, we quantitatively studied the SEI formation process through an amorphous silicon thin film to prevent binder and conductive carbon interferences in data interpretation. In addition, the volume expansion of an amorphous silicon thin film is isotropic without two-phase lithiation conversion. Thus, the research object is maximally simplified. In this work, we set up a method based on TGC to quantify Li loss in Li—Si alloy. The primary chemical mechanism is that only the Li—Si alloy can react with the inert protic solvent and produce hydrogen (H₂), while the SEI components cannot. This method allowed us to quantitatively distinguish the loss of active lithium consumed by SEI formation and the trapped Li—Si alloying caused by the kinetic limitation. We investigated SEI evolution in the first cycle and SEI growth in subsequent cycles was thoroughly studied under controlled electrochemical conditions. The results show that the SEI formation starts at 0.5 V and stops growing when the lithiation voltage reaches 0.24 V (vs. Li⁺/Li) at the first cycle. This indicates that SEI is not a linear growth in Si thin film anode during the whole lithiation process. Upon subsequent cycling, the accumulation of SEI is the dominant factor for Li loss, with only a marginal increase in trapped Li—Si alloy. These findings provide a unique understanding of SEI growth and evolution in amorphous silicon thin films, and quantitative information about the lithium inventory loss caused by different reasons. The developed workflow can be widely applied to the lithium inventory loss study for other conversion or alloying type anode materials.

Results and Discussion

Solvent Screening for TGC Methodology.

To develop the TGC method for Li quantification in Li—Si alloy, we firstly explored the reaction mechanisms between Li—Si alloy and protic solutions (water/ethanol). The chemical reaction formula is shown as follows:

2LiₓSi(s)+2xH⁺(aq.)=2xLi⁺(aq.)+2Si(s)+xH₂ (1)

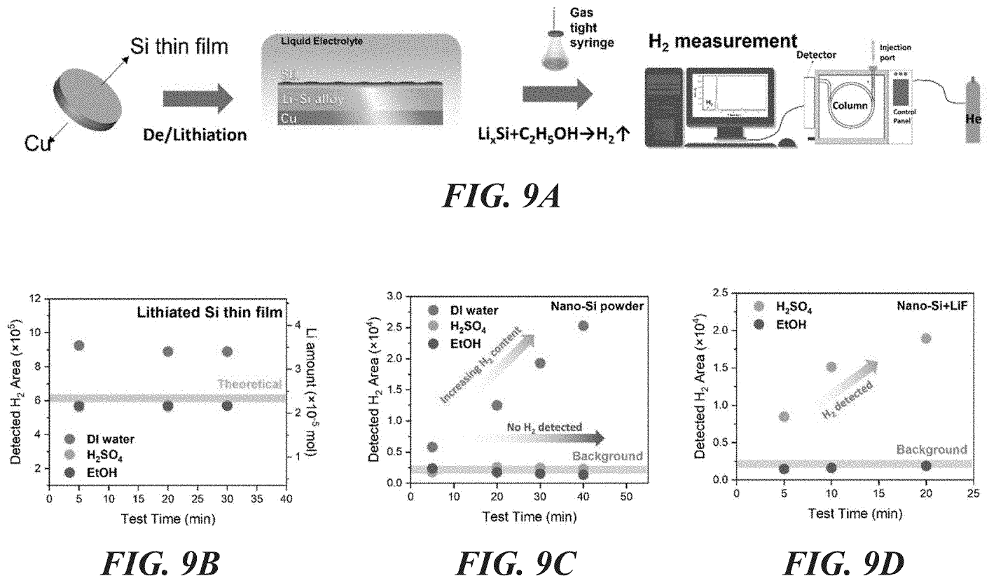

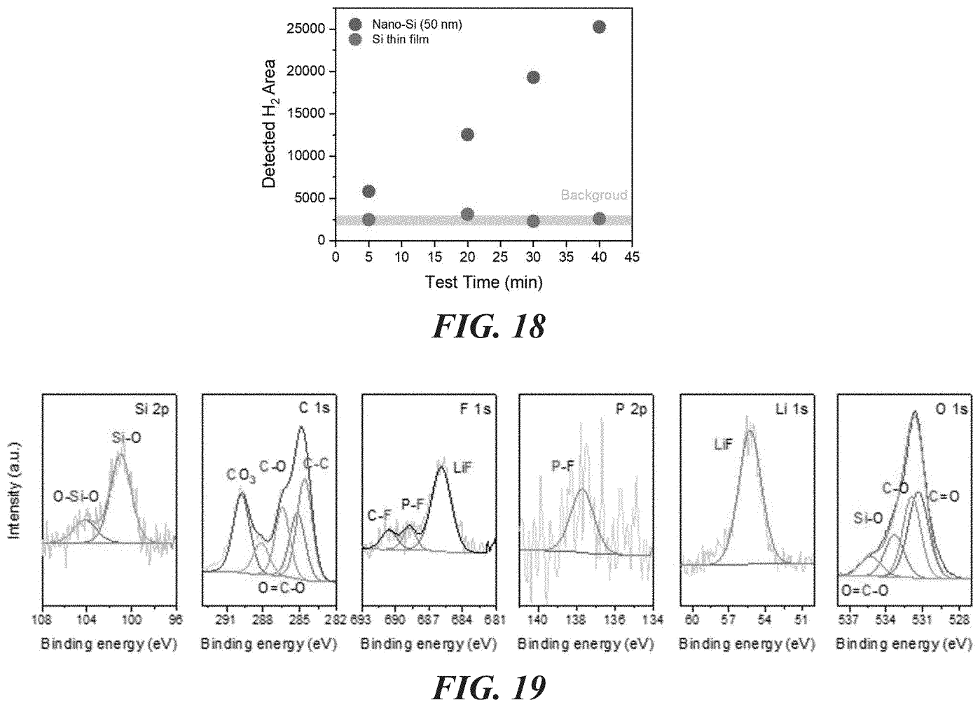

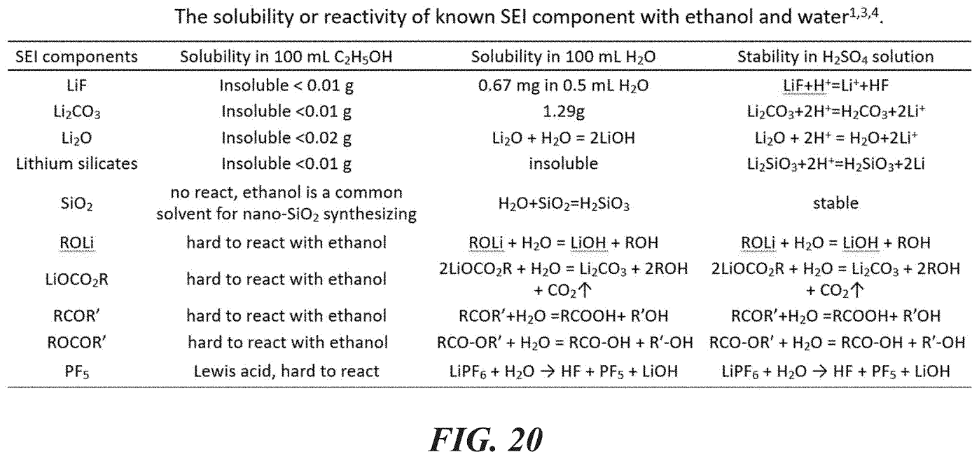

Note that pure Si is one of the reaction products, and it undergoes multi-step reactions with H₂O to generate H₂ gas. Therefore, the suitable solvent selection needs to meet the following criteria: 1) chemically inert with Si and only reacting with Li—Si alloy to generate H₂ gas; 2) chemically inert with the SEI components, with no H₂ generation. Starting with three common solvents, H₂O, H₂SO₄, and C₂H₅OH (EtOH), a controlled TGC experiment was conducted with fully lithiated Si thin film electrodes, nano-Si with/without LiF mixtures. FIG. 9b shows that the amount of H₂ generated from lithiated Si thin film (lithiated to 0.01 V vs. Li⁺/Li) varies when using different titration solvents. The theoretical amount of H₂ calculated based on equation (1) is displayed in a green horizontal line for reference. The generated H₂ amount when using H₂SO₄ and EtOH are close to the theoretical value (details in FIG. 17). The excess H₂ amount for H₂O solvent manifests that H₂O undergoes side reactions with the lithiated silicon anode as discussed above. Another control experiment was conducted using nano-Si powder to confirm this observation, the related discussion can be found in Supplementary Information (FIG. 18 and Note 15). FIG. 9c shows that H₂ is generated from bare nano-Si when mixing with H₂O, while no H₂ can be detected when using H₂SO₄ or EtOH solvents. Previous literature reported concentrated alkaline solutions are known to accelerate Si oxidation to produce H₂. In addition to Li—Si alloys, the solubility and reactivity of SEI components in the three solvents also need to be considered (SEI components and results are summarized in FIG. 19 and Table of FIG. 20). Most of the SEI components are stable with selected solvents except for LiF. FIG. 9d shows that nano-Si mixed with LiF will react and generate H₂ when H₂SO₄ solvent is used. This is due to the HF formation from LiF in acidic environments, which further reacts with Si to yield H₂. Neither H₂O nor H₂SO₄ solution is suitable for TGC experiments on the quantification of Li in Li—Si alloy. EtOH as a mild protic solvent is chemically stable with Si SEI components. At the same time, EtOH can react with Li—Si alloy to generate H₂ for Li quantification. Therefore it is chosen as the solvent for the subsequent TGC study.

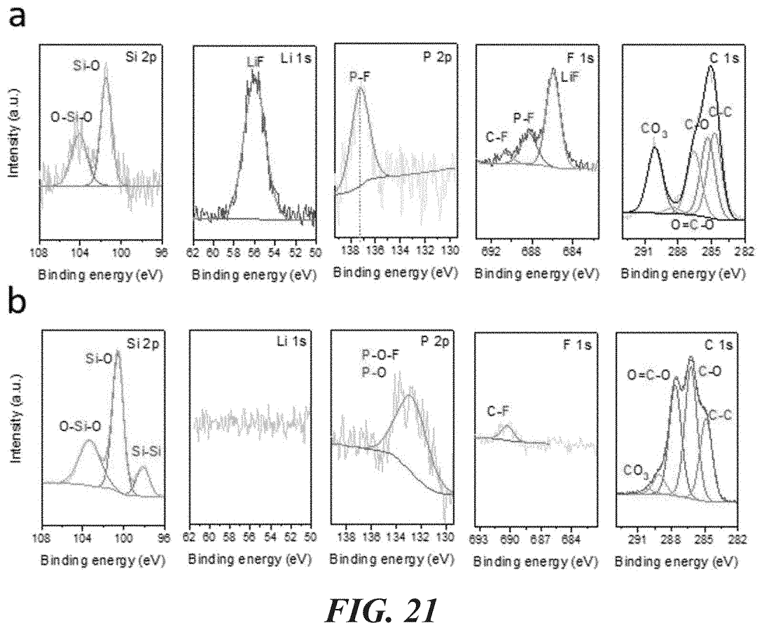

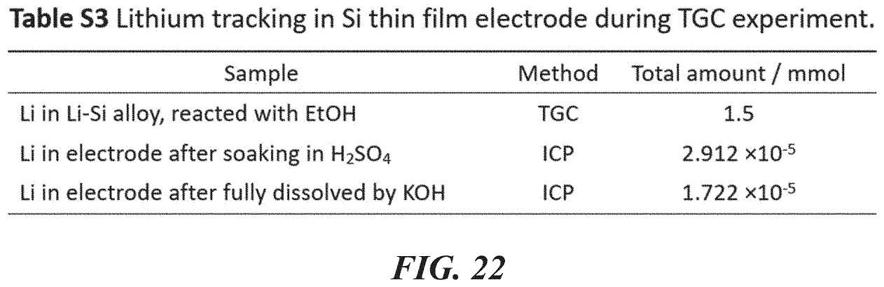

The total amount of Li within Si anode equals the sum of Li amount in SEI (Li⁺) and Li—Si alloy, since some Li reacts with Si to form Li—Si alloy, while some are irreversibly consumed to form SEI during lithiation. The Li content in Li—Si alloy can be determined by the TGC method. The Li content in SEI can be calculated using the total Li amount obtained from electrochemical testing. To verify that the Li—Si alloy is fully reacted with titration solvent, inductively coupled plasma mass spectrometry (ICP-MS) was conducted on the Si thin film samples after titration with EtOH. No additional Li-ions were detected in the filtered solution, indicating that the EtOH solvent fully reacted with the Li—Si alloy samples (FIG. 21, table of FIG. 22).

Quantification and Qualification on the First Cycle Li Loss in Si Thin Film Anode.

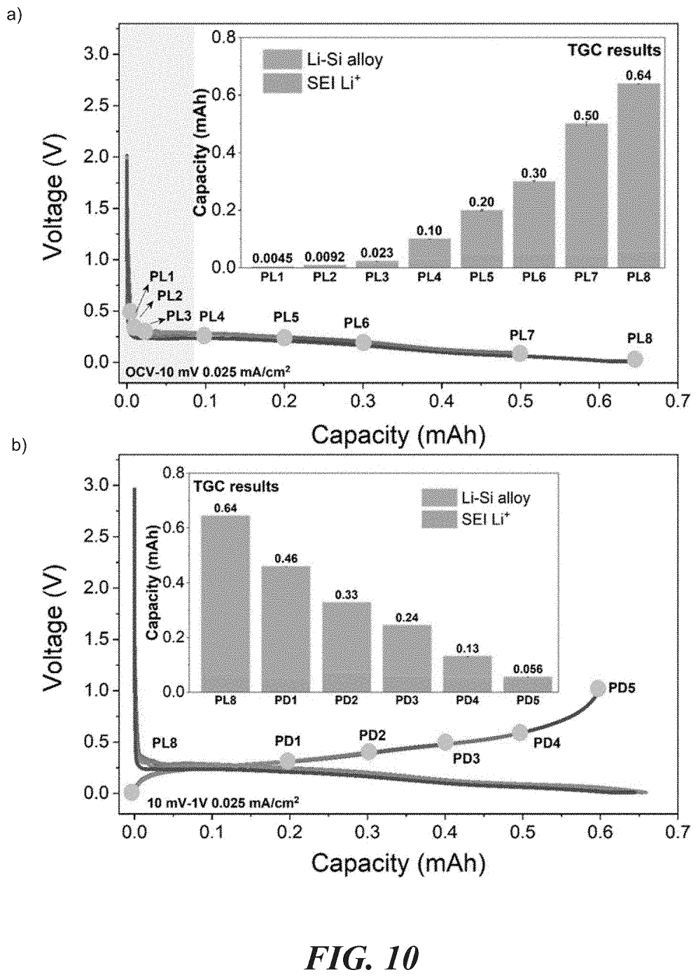

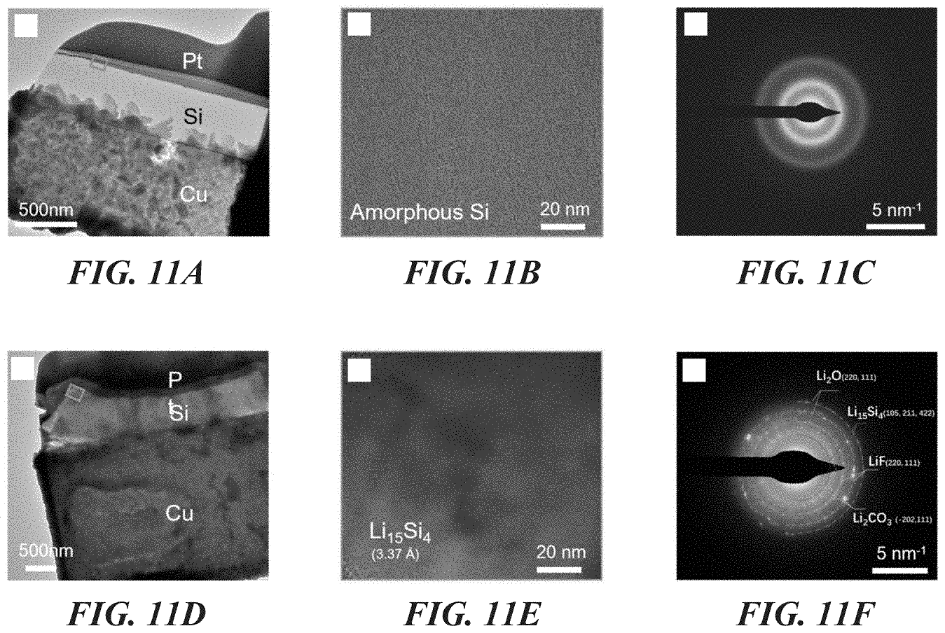

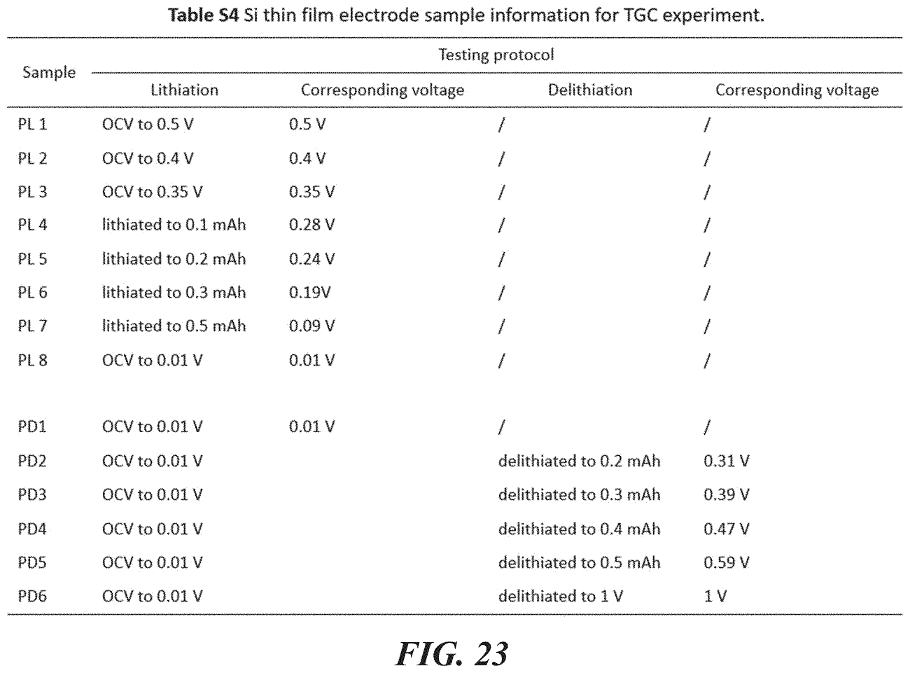

Different lithiation/delithiation states were selected by controlling the Li Si half-cell cut-off voltage or capacity to quantify Li—Si alloy by the TGC method (more details in table of FIG. 23). FIG. 10a displays the electrochemical discharge profiles of the lithiation processes with the corresponding TGC results. From the electrochemical data, at PL 1 (0.5 V), the lithiation capacity is 0.0045 mAh. However, no H₂ was detected at 0.5 V (PL 1) when the lithiation reaction starts, indicating the SEI formation occurs before Li—Si alloying reaction. H₂ gas was detected from 0.35 V vs. Li+/Li (PL 3), suggesting the beginning of the alloying reaction is between 0.4 V and 0.35 V vs. Li+/Li (PL 2 and PL 3). The Li—Si alloy and SEI amount both increase when they reached potential for PL 4 and PL 5. While it is interesting to observe that the SEI stops growing after 0.24 V vs. Li+/Li (PL 5) and remains the same until 0.01 V vs. Li+/Li (PL 8). The completion of SEI growth demonstrated that new surfaces would no longer be formed at the initial lithiation process of the Si thin film anode.

The electrodes were then charged to different delithiation states after discharged to 0.01 V (vs. Li+/Li) (FIG. 10b). From PD 1 to PD 5, Li should be gradually delithiated from the Li—Si alloy. TGC results reflect the process clearly, showing a decreasing trend of Li—Si alloy amount during the delithiation process. However, the SEI amount has no noticeable change during the delithiation process. At the delithiated state of PD 6 (1 V vs. Lr/Li), H₂ gas was still detectable, indicating the presence of trapped Li—Si alloy. Thus, Li loss during the first cycle in Si thin film anode comes from both SEI and the trapped Li—Si alloy. Specifically, 91% of the capacity loss in the first cycle is due to SEI formation, and the remaining 9% is due to the trapped Li in the Li—Si alloy.

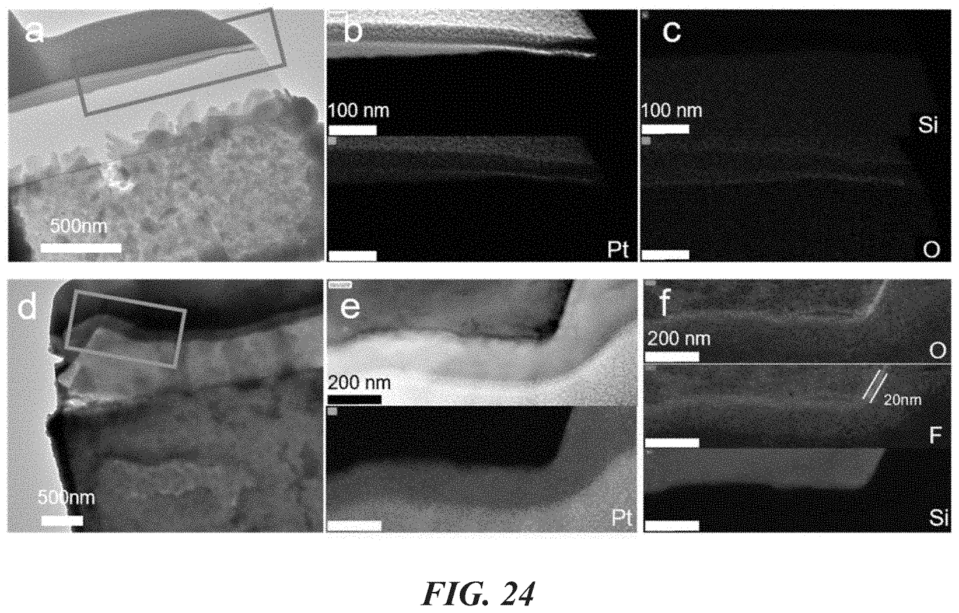

Cryo-TEM coupled with cryogenic lift-out methodology was applied to investigate the trapped Li—Si alloy after the first cycle. Cryogenic condition is critical here because lithiated silicon is highly sensitive to the electron beam, inducing sample damage at room temperature. In FIG. 11a, the pristine Si thin film sample is in the middle layer of Pt (top) and Cu current collector (bottom). The as-deposited Si thin film is 500 nm thick with a negligible native oxide layer on the surface, confirmed by EDS mappings of Pt, Si, O, and Cu in FIG. 24a. No crystal lattice was identified in pristine Si thin film sample from high-resolution TEM (HRTEM) image (FIG. 11b) in the region highlighted by the green squares in FIG. 11a. The selected area electron diffraction (SAED) in FIG. 11c shows halo features, demonstrating the amorphous nature of the deposited Si sample. After the first cycle, the electrode thickness increased to 530 nm, and 20 nm thick SEI was formed on the surface. The SEI layer can be depicted by the uniform elemental distribution of O and F on the surface, as shown in FIG. 24b. The region highlighted by the orange frame in FIG. 11d was further analyzed by HRTEM and SAED (FIGS. 11e and 11f). It can be confirmed from the SAED pattern in FIG. 11e that the SEI is composed of polycrystalline and amorphous species, including Li₂O, Li₂CO3, and LiF. In addition, the (1 0 5), (2 1 1), and (4 2 2) crystallographic planes of Li15Si4 are also found in the SAED pattern. The presence of Li15Si4 is consistent with the TGC results that trapped Li—Si alloy exists in Si thin film anode. HRTEM image (FIG. 11e) further exhibits that the trapped Li—Si alloy regions intermixed with SEI. Therefore, it is suggested the blocking of the electronic pathway can induce the formation of trapped Li—Si alloy from the SEI during the delithiation process.

Quantifying Extended Cycles Li Loss in Si Thin Film Anode.

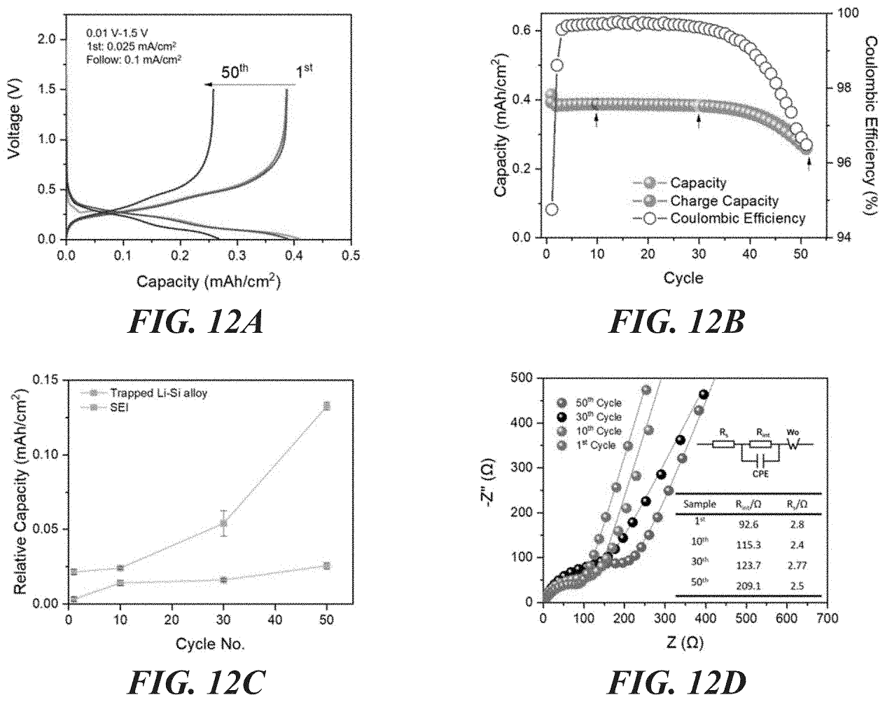

We further investigated the SEI and trapped Li—Si alloy amount during extended cycles. The charge-discharge profiles and cycling performance of Si thin film half cells are shown in FIGS. 12a & 12b. The current density used in the first cycle is 0.025 mA/cm² and then switched to 0.10 mA/cm² for subsequent cycles. The initial lithiation capacity is 0.42 mAh/cm², with an initial CE of 93%. No capacity decay is observed during the initial 30 cycles, while severe degradation occurs with the decreased CE afterward. The TGC measurements were conducted at cycle numbers 10, 30, and 50, respectively, to pinpoint the degradation mechanism. The total capacity loss, the amount of SEI, and trapped Li—Si alloy were obtained through the following equation 2:

Σ₁^{N}Q_{Capacity loss}=Σ₁^{N}Q_{SEI}+Σ₁^{N}Q_{Trapped Li} (2)

Where N represents the cycle number, Q_{Capacity loss}, Q_{SEI}, and Q_{Trapped Li} refers to capacity loss from each component at each cycle. As shown in FIG. 12c, the primary capacity loss during cycling is the continuous formation of SEI, which accumulates much faster than trapped Li—Si alloy. Electrochemical impedance spectroscopy (EIS) was further conducted to explore the interphase impedance changes during extended cycles. FIG. 12d shows a correlation between interphase impedance and SEI growth. The interphase impedance is 92.6Ω at the first cycle and increases to 115.3 Ω, 123.7Ω and 209.1Ω over 10, 30 and 50 cycles respectively, indicating that SEI changed upon cycling.

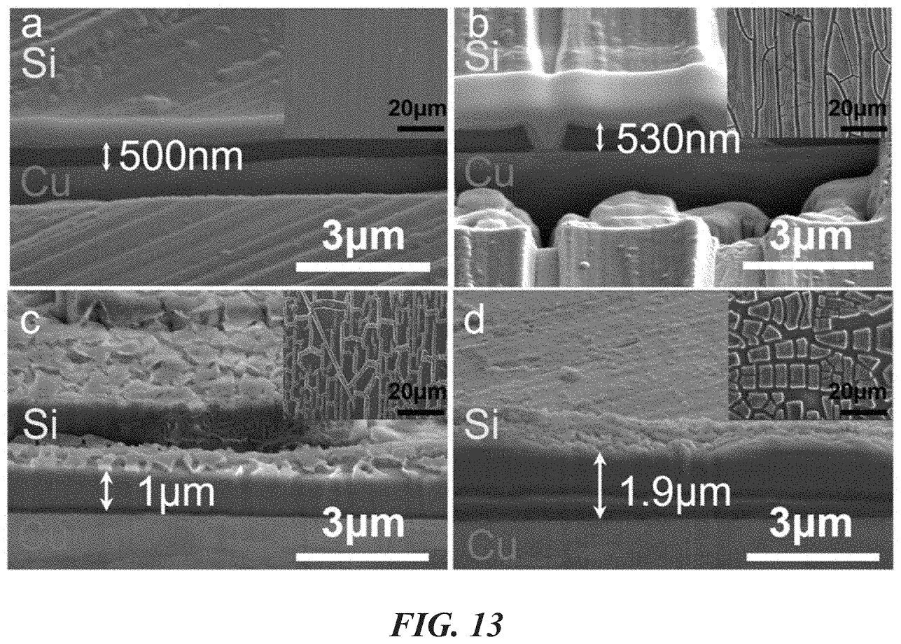

Cross-section images were captured using the Cryo-focused ion beam scanning electron microscopy (FIB-SEM). FIG. 13a shows a dense and flat 500 nm thick Si thin film as the pristine state, but cracks appear on the surface due to volume change after the 1st cycle. After 10 and 30 cycles, the surface starts to pulverize into small fragments. Considering that the specific capacity barely changes within 30 cycles, the total amount of active material should not be affected by those cracks. As shown in FIG. 13, the electrode thickness increases after the cycling. Consequently, these cracks drastically increase the surface area of exposed Si and lead to continuous SEI growth.

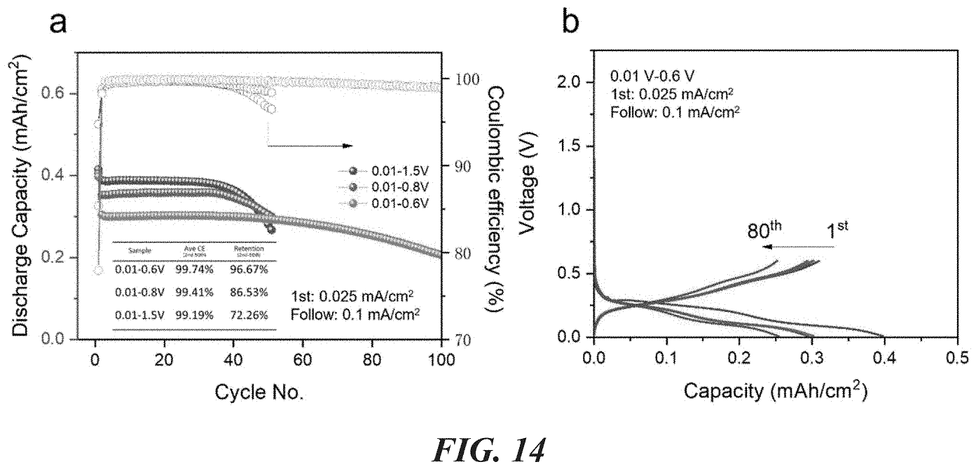

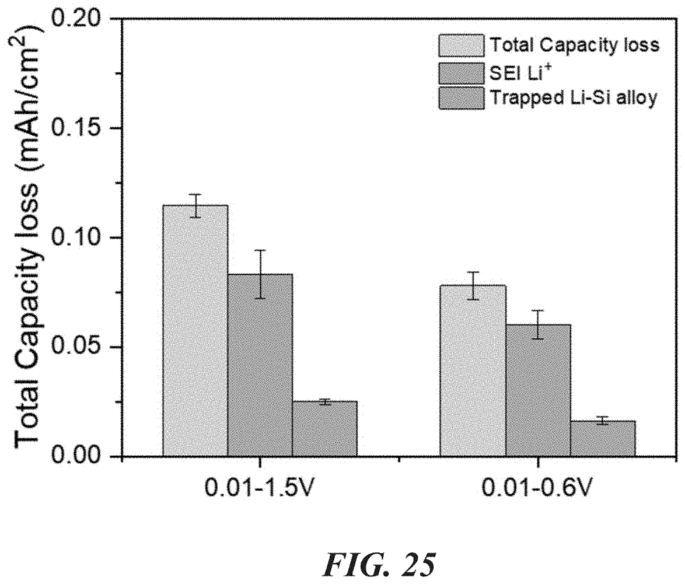

The TGC results conclude that the initial SEI growth stops after the first lithiation to 0.24 V. It can be considered that the majority of the capacity is achieved with the voltage lower than 0.24V, where no SEI grows. This fact indicates that voltage control should be effective in improving Si anode cycling. The upper cut-off voltage can be lowered down to validate this hypothesis. FIGS. 14a & 14b show the cycling performance of Si thin film in half cells with different upper cut-off voltages, including 0.6 V, 0.8 V, and 1.5 V. The initial CE is 77.96%, 85.37%, and 94.76%, respectively. The decreased ICE is due to the incomplete delithiation due to the limitation from upper cut-off voltage. The average CE from 2nd and 50th cycles for 0.6 V, 0.8 V and 1.5 V cut-off is 99.74%, 99.41%, 99.19% and the capacity retention is 96.67%, 86.53%, 72.26%, respectively. The cycle stability and CEs are significantly improved with the decrease of delithiation potential. TGC results further demonstrate (FIG. 25) that both the SEI and trapped Li—Si alloy amount have been reduced in 0.6 V cells compared to 1.5 V cells. The decrease in the total SEI amount reduces the chance of the Li—Si alloy being isolated by the SEI, thus reducing the amount of trapped Li—Si alloy. The percentage of used Si anode controlled by cut-off voltage can be mimicked in a full cell setup. Changing the capacity ratio between the negative and positive electrodes (N/P ratio) would have a similar effect as the voltage control.

Correlating the amount of Li inventory loss with micro and nanostructures, we proposed the mechanism of lithium loss in the amorphous silicon thin film anode. The dominant reason for Li inventory loss is the formation of SEI: the electrolyte decomposes on the electrode surface to form organic and inorganic lithium-containing compounds. Despite the conventional understanding that large volume changes in silicon anodes during the lithiation process results in continuous SEI growth, the quantitative analysis conducted in this works shows no clear relationship between the volume expansion and SEI growth. SEI stops growing after 0.24 V during the initial lithiation process. An increase in SEI during the subsequent cycling is likely due to the formation of cracks during the delithiation process, which increases the specific surface area of the electrode. Therefore, controlling the delithiation process and its corresponding volume change is critical to achieving improved cycling stability. The secondary reason for Li inventory loss is the formation of trapped Li—Si alloy, which was identified by both TGC and Cryo-TEM results. The trapped Li—Si alloy during cycling contributes to capacity loss. Crystalline Li15Si4 is the most stable phase of Li—Si alloy at room temperature, and it is derived from the amorphous LixSi after lithiation to 0.01 V (vs. Li/Li⁺). The cryo-TEM image shows that trapped Li15Si4 is encapsulated by the insulating SEI, leading to the loss of electronic conductive pathways. This indicates the amount of trapped Li—Si alloy can be reduced by controlling the amount of SEI formation. The TGC results in FIG. 25 demonstrate that the better-controlled SEI can reduce the trapped Li—Si alloy. Overall, the Li inventory loss in amorphous Si thin film anode consists of SEI and trapped Li—Si alloy. SEI is the primary reason for capacity decay.

In summary, a developed TGC method is designed to investigate the Li inventory loss in Si thin film anode. The choice of titration solvent is crucial for accurate quantification, where the chemical properties of both the Li—Si alloy and SEI components need to be thoroughly considered. Ethanol is selected as the titration solvent since only the Li—Si alloy can be titrated to generate H₂, rather than other side reactions induced by common SEI components. With the optimized TGC method, we demonstrated that inventory Lithium loss in Si thin film anode is mainly caused by continuous SEI formation along with cycling. For the first lithiation process, SEI formation stops when the voltage reaches 0.24 V, while SEI amount shows negligible changes during the first delithiation process. Trapped Li—Si alloy can be detected after delithiated to 1.5 V by both TGC and cryo-TEM, which is intermix with the insulating SEI components. Both the trapped Li—Si alloy and SEI grow with the cycling, while SEI consumes most of the Lithium inventory. We believe the cracks induced by the volume change increase the surface area of Si so that more SEI will be formed with trapped Li—Si alloy. Controlling the upper cut-off voltage can mitigate SEI formation, resulting in less trapped Li—Si alloy and better cycling stability. We validate the TGC method in Si thin film anode and promote the understanding of the Si anode degradation mechanism to a new level. We believe this approach can be universally applied in Silicon-based or other alloy-type anode material for accelerating the development of high energy density secondary batteries.

Experimental Procedures

Preparation of the Si Thin Film.

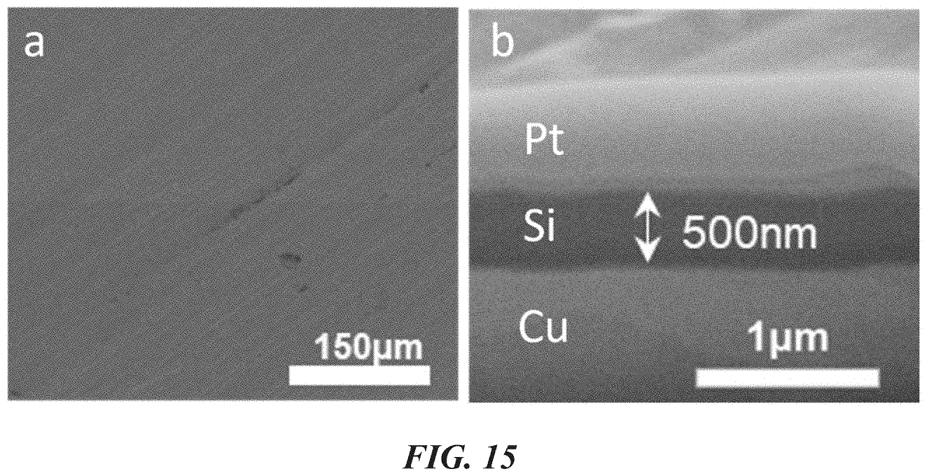

Silicon (Si) thin film with 500 nm thickness was used as the anode in this study. The film was deposited on Cu foil (10 μm, MTI) by magnetron sputter deposition with an RF power supply using Si (99.99%) target (3 inches in diameter and 0.125 inches in thickness). The deposition was conducted in Discovery 18 sputtering system made by Denton Vacuum LLC. A base pressure of 8×10-7 Torr was achieved before the deposition. An Argon gas pressure of 5×10-3 Torr and a power level of 350 W were applied during the deposition. The density of silicon thin film was around 2.2 g/cm³, measured by quartz crystal microbalance (QCM). The morphology is shown in FIG. 15. The titrants included DI H₂O, 0.07M H₂SO₄ solution (diluted from 18.4M H₂SO₄, Fisher Chemical), Ethanol (200 proof anhydrous ethanol, Koptec, ≥99.9%). Nano-sized silicon powder (Nano-Si, <50 nm, Alfa Aesar) and lithium fluoride (LiF, ≥99.99% trace metals basis, Sigma Aldrich) are used to demonstrate the reaction between Si and solvent.

Electrochemical Measurements.

The Si thin film with a diameter of 0.55 inches as the working electrode was assembled into a 2032 type coin cell in an Ar-filled glove box. Li metal (1 mm thick, 0.5 inches in diameter) was employed as the counter electrode. The electrolyte was 1 mol/L LiPF6 dissolved in ethylene carbonate (EC): dimethyl carbonate (DMC) (1:1, v/v) with 10% of fluoroethylene carbonate (FEC), the electrolyte amount was fixed as 75 uL per cell. The half-cell was cycled between 10 mV and 1.5 V at room temperature at a current density of 0.025 mA/cm² during the first cycle and 0.1 mA/cm² for subsequent cycles, using a Neware battery tester. We controlled different lithiation states for TGC samples during lithiation by limiting either the cut-off voltage or the cut-off capacity. Characterization of EIS was performed using a BioLogic SP-150 workstation under OCV with the 1 MHz-10 mHz as the frequency range.

Materials Characterizations.

Titration-Gas Chromatography.

The TGC experiments were performed using a Shimadzu GC-2010 Plus Tracera equipped with a BID detector. The Split temperature was kept at 200° C. with a split ratio of 2.5 (split vent flow: 20.58 ml/min, column gas flow: 8.22 ml/min, purge flow: 0.5 ml/min). Column temperature (RT-Msieve 5A, 0.53 mm) was kept at 40° C., and the BID detector was held at 235° C. Helium (99.9999%) was used as the carrier gas, and the BID detector gas flow rate was 50 ml/min. After cycling to the designed condition, the cycled cells were dissembled in the Ar-filled glovebox, then the cycled electrode was transferred into the glass vial with a rubber septum for air-tight sealing. The whole process was conducted in the glovebox to prevent air exposure. Then the vials will be transferred for titrate injection. The generated gases after titration were injected into the machine via a 50 μL Gastight Hamilton syringe, as shown in FIG. 9a. The related calibration procedure can be found in supplementary information.

Inductively Coupled Plasma Mass Spectrometry (ICP-MS).

To verify that the Li—Si alloy is fully reacted with titration solvent, the Si thin film samples after titration with EtOH was confirmed by ICP-MS (iCAP RQ, Thermo Fisher Scientific). The sample soaked in a 0.5 M H₂SO₄ solution overnight for fully dissolve. Then the supernatant was collected and further diluted with matrix solution for ICP check.

X-Ray Photoelectron Spectroscopy.

The XPS was conducted on Kratos AXIS-Supra, using Al target as the X-ray source under 10-9 Torr pressure. The cycled electrodes for XPS tests were rinsed by DMC and then transferred to the nitrogen-filled glovebox directly connected to the chamber without air exposure. Survey scans were performed with a step size of 1.0 eV, followed by a fine scan with 0.1 eV resolution. The spectra were analyzed by CasaXPS software to different chemical species.

Cryogenic Focused Ion Beam Scanning Electron Microscopy.

The FIB-SEM was conducted on the FEI Scios Dual-beam microscopy; the Si thin film cells after cycling were disassembled in the Ar-filled glovebox. The samples were transferred to the FIB chamber without any exposure to air. The electron beam operating voltage was 5 kV, and the stage was cooled with liquid nitrogen to −180° C. or below. Sample cross-sections were exposed using a 1 nA ion beam current and cleaned at 0.1 nA.

Cryogenic Lift-Out Methodology and Cryogenic Transmission Electron Microscopy.

The Cryo-FIB preparation process is required as described above. The Pt was deposited for surface protection from the ion beam and connected lamella with the tungsten probe for lamella lift-out and mounting, and more details can be obtained in our previous work. The lift-out sample from the FIB chamber under vacuum using an air-free quick loader (FEI) and transfer the sample in an Ar-filled glovebox. A TEM cryo-holder (Gatan) was used to load the sample where TEM grids were immersed in liquid nitrogen and then mounted onto the holder via a cryo-transfer workstation. The whole TEM sample preparation and transfer process prevent any sample contact with air at room temperature. STEM/EDS mapping, TEM images, and SAED patterns were conducted on a JEOL JEM-2800F TEM, equipped with a Gatan Oneview camera operated at 200 kV.

TGC Calibration.

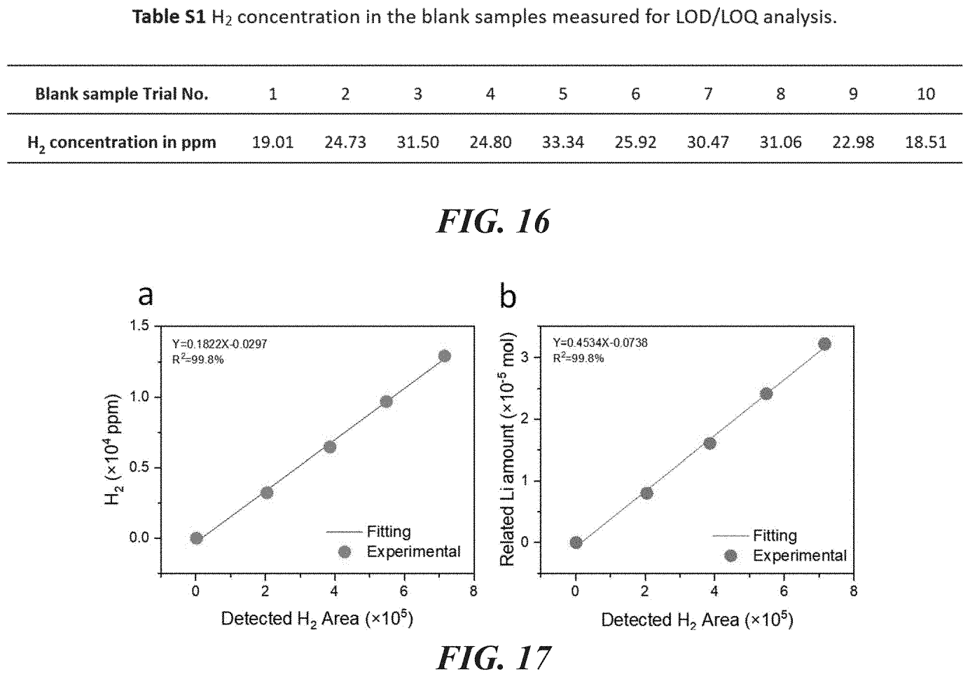

For calibration of H₂ concentration, we produced H₂ gas from the reaction of sodium with DI water in the same way as our previous work reported. To put it briefly, we used the gastight needle to obtain 5 μL, 10 μL, 15 μL, 20 μL, 25 μL, and 30 μL of H₂ into the GC instrument to obtain the corresponding chromatographic peak area. Plot the chromatographic peak area and the corresponding amount of H₂ to obtain a calibration curve, as shown in FIG. 17. The limit of detection/limit of quantification (LOD/LOQ) was determined as the same way as our previous work reported. The concentration of hydrogen in the air is 0.000053%. To get the LOD/LOQ values, 30 μl of the air as blank sample was injected into GC by the same gas-tight syringe as used for the H₂ measurement, based on the definition of LOD/LOQ, the calculated LOD/LOQ from blank sample is 16.37 ppm and 49.62 ppm respectively, corresponding to 0.001 mAh and 0.003 mAh of capacity in the designed TGC system. For TGC measurement, we put the sample in a septum sealed glass vial, and after injecting the solvent (DI water, Ethanol (200 proof anhydrous), and 0.07 M H₂SO₄ solution), 30 μL of gas was obtained and sent to the GC instrument for testing. H₂ concentration in the blank samples measured for LOD/LOQ analysis is shown in the table of FIG. 16.

Conversion.

Calculation of Theoretical Value (Reference Green Line) in FIG. 17a.

Based on the QCM results, the mass loading of Si thin film electrode is 0.169 mg (d=14 mm). The theoretical lithiation product of Si anode at room temperature is Li₁₅Si₄ (3580 mAh/g). Assuming all the Si can be fully lithiated to Li₁₅Si₄ according to the reaction as follows:

Li₁₅Si₄=15Li⁺+4Si+15e⁻

The theoretical capacity of 500 nm thick Si film is:

0.11×10⁻³ g/cm²×3580 mAh/g=0.394 mAh/cm²

Conversion between milliampere-hours and mol of Li:

1 C=1 A·s=1000 mA×1/3600 h=1/3.6 mAh

1 C=6.25×10¹⁸e⁻=1.038×10−5 mol e⁻

LiₓSi=xLi⁺+Si+xe⁻

1 mAh=3.7368×10⁻⁵ mol Li

The Nano-Si powder was chosen for the control experiment because the reaction rate of Si and H₂O highly related to Si particle size. It has been demonstrated that Nano-size Si (˜10 nm) reacts with H₂O/OH⁻ to generate H₂ 1000 times faster than bulk Si due to the high surface area per volume.² In this work, the pristine Si thin film can be considered as bulk Si due to its dense morphology. The control experiment on pristine Si thin film with H₂O showed no H₂ generation while the Nano-Si powder with H₂O can generate H₂ within 5 mins, as shown in FIG. 18.

Though pristine Si thin film is dense, the morphology would change after lithiation-delithiation process, which possibly leads to the generation of small size domain. To exclude the detecting error from the morphology change, we directly use the Nano-Si powder as the extreme case. The stability of ethanol solution with the Nano-Si powder fully excludes the possibility of extra H₂ generation. Therefore, we choose Nano-Si powder for solvent screening.

To verify that the Li—Si alloy was fully reacted, ICP-MS was conducted on the delithiated silicon thin film sample. After the TGC experiment, the delithiated Si thin film electrode was rinsed by EtOH and then immersed in 0.5 M H₂SO₄ solution for 2 days to remove the SEI components. The Li amount in the solution was found to be 1.722×10⁻⁵ mmol, which is five orders of magnitude smaller than the one got from the TGC test. This indicated that some of the organic components can dissolve in EtOH solvent, and no unreacted Li—Si alloy was left in SEI. Further, the above Si thin film sample was dissolved in 6 M KOH solution, and the Li amount in the solution was found to be 2.912×10⁻⁵ mmol. This proves that there is no unreacted Li—Si alloy in the Si thin film as well. Besides, there is no Li signal detected on the surface of delithiated Si thin film after removing SEI. Therefore, it can be concluded that the solvent reacted fully with the Li—Si alloy.

Quantifying Inactive Lithium in Lithium Metal Batteries

Lithium metal anodes offer high theoretical capacities (3,860 milliampere-hours per gram), but rechargeable batteries built with such anodes suffer from dendrite growth and low CE (the ratio of charge output to charge input), preventing their commercial adoption. The formation of inactive (‘dead’) lithium—which consists of both (electro)chemically formed Li⁺ compounds in the solid electrolyte interphase and electrically isolated unreacted metallic Li⁰—causes capacity loss and safety hazards. Quantitatively distinguishing between Li⁺ in components of the solid electrolyte interphase and unreacted metallic Li⁰ has not been possible, owing to the lack of effective diagnostic tools. Optical microscopy, in situ environmental transmission electron microscopy, X-ray microtomography and magnetic resonance imaging provide a morphological perspective with little chemical information. Nuclear magnetic resonance, X-ray photoelectron spectroscopy and cryogenic transmission electron microscopy, can distinguish between Li⁺ in the solid electrolyte interphase and metallic Li⁰, but their detection ranges are limited to surfaces or local regions. Here we establish the analytical method of titration gas chromatography to quantify the contribution of unreacted metallic Li⁰ to the total amount of inactive lithium. We identify the unreacted metallic Li⁰, not the (electro) chemically formed Li⁺ in the solid electrolyte interphase, as the dominant source of inactive lithium and capacity loss. By coupling the unreacted metallic Li⁰ content to observations of its local microstructure and nanostructure by cryogenic electron microscopy (both scanning and transmission), we also establish the formation mechanism of inactive lithium in different types of electrolytes and determine the underlying cause of low CE in plating and stripping (the charge and discharge processes, respectively, in a full cell) of lithium metal anodes. We propose strategies for making lithium plating and stripping more efficient so that lithium metal anodes can be used for next-generation high-energy batteries.

Inactive lithium consists of diverse Li⁺ compounds within the SEI, such as LiF, Li₂CO₃, Li₂O, ROCO₂Li, and of unreacted metallic Li⁰ which is isolated by the SEI from the electronic conductive pathway. It is generally assumed that low CE mostly arises from continuous repair of SEI fractures, which consumes both the electrolyte and active Li metal, although some researchers have suggested that unreacted metallic Li⁰ may increase the tortuosity at the electrode/electrolyte interface and decrease the CE in this way. These assumptions and hypotheses are mostly based on observation, and the contribution to capacity loss from SEI formation has not been successfully quantified. Consequently, efforts to make Li metal a valid anode material may be misdirected. Differentiating and quantifying the Li⁺ and Li⁰ remaining on the electrode after stripping is key to understanding the mechanisms leading to capacity decay.

In our work, the pivotal difference exploited between the SEI Li⁺ compounds and metallic Li⁰ is their chemical reactivity: only the metallic Li⁰ reacts with protic solvents (such as H₂O) and generates hydrogen gas (H₂). The solubility and reactivity of known SEI species with H₂O are listed in Extended Data Table 1. The possible presence of LiH in inactive Li might affect the quantification of metallic Li⁰ because LiH also reacts with water and produces H₂, so it was important to exclude this possibility in our results (see Methods for details). We combine H₂O titration (the step in which all metallic Li⁰ is reacted) and gas chromatography (the subsequent step to quantify the H₂ generated in the reaction) into a single analytical tool, hereafter referred to as titration-gas chromatography (TGC; schematic process in FIG. 1), which is able to quantify the content of metallic Li⁰ based on the reaction of:

2Li+2H₂O→2LiOH+H₂↑

When this is coupled with an advanced barrier ionization H₂ detector, the measurement of metallic Li⁰ in the designed system is accurate to 10-7 g. The complete TGC methodologies are illustrated in Methods. We then applied TGC to correlate the origin of inactive Li with the CE in Li∥Cu half-cells. As the CE of Li metal varies greatly with electrolyte properties and current density, we compared two representative electrolytes, a high-concentration electrolyte (HCE; 4 M lithium bis(fluoro sulfonyl)imide (LiFSI) and 2 M lithium bis(trifluoromethane sulfonyl)imide (LiTFSI) in 1,2-dimethoxyethane (DME)) and a commercial carbonate electrolyte (CCE; 1 M LiPF6 in ethylene carbonate/ethyl methyl carbonate (EC/EMC)), at three stripping rates (0.5 mA cm-2, 2.5 mA cm-2 and 5.0 mA cm-2; all plating at 0.5 mA cm-2 for 2 hours). In addition, we examined six other electrolytes with a variety of salts, solvents and additives that frequently appear in the literature: 2 M LiFSI in DMC, 0.5 M LiTFSI in DME/1,3-dioxolane (DOL), 1 M LiTFSI-DME/DOL, 1 M LiTFSI-DME/DOL plus 2% LiNO3, CCE plus Cs⁺, and CCE plus FEC.

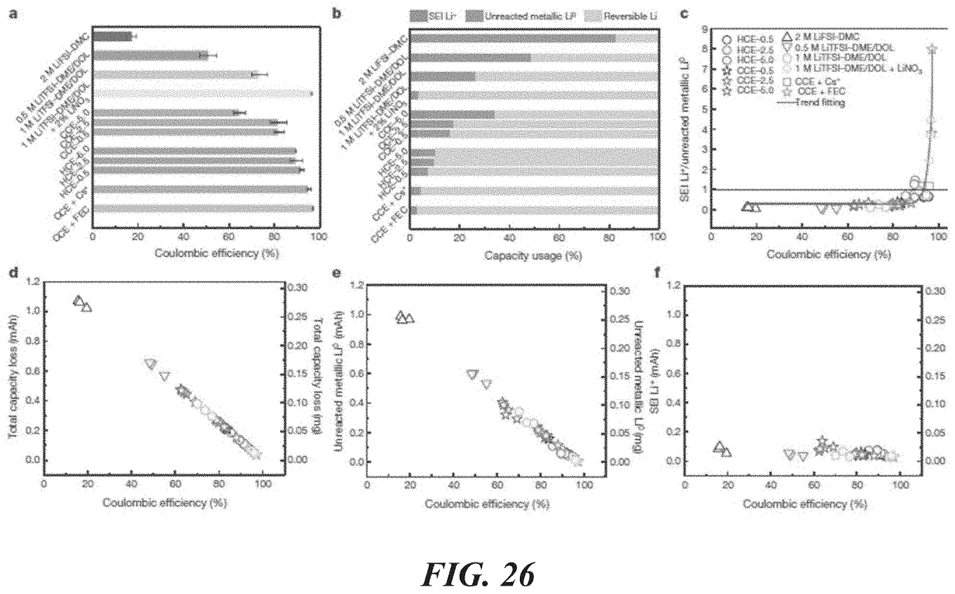

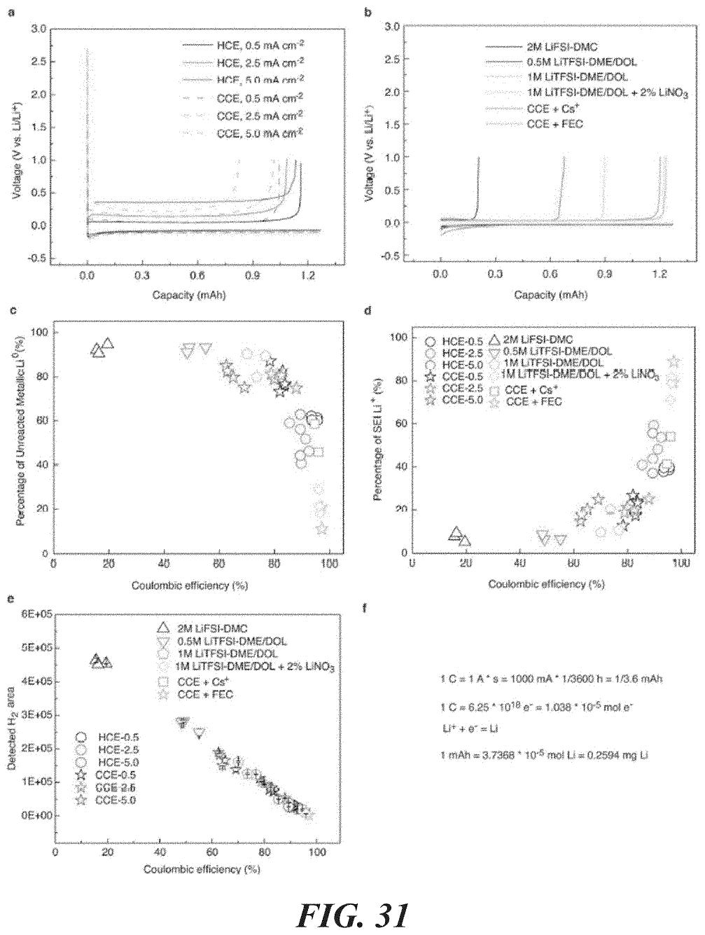

FIG. 26 shows quantitative differentiation of inactive Li by the TGC method. In FIG. 26a shows average first-cycle CE of Li∥Cu cells under different testing conditions. Eight electrolytes (HCE, CCE, 2 M LiFSI-DMC, 0.5 M LiTFSI-DME/DOL, 1 M LiTFSI-DME/DOL, 1 M LiTFSI-DME/DOL+2% LiNO3, CCE+Cs+ and CCE+FEC) and three stripping rates (0.5 mA cm-2, 2.5 mA cm-2 and 5.0 mA cm-2 to 1 V) are used. In all electrolytes, Li was plated at 0.5 mA cm-2 for 2 hours (1 mAh cm-2). HCE and CCE were selected for the three stripping rates study. Li formed in the rest electrolytes were stripped at 0.5 mA cm-2 to 1 V. At each condition, three to five cells were tested to obtain better statistics. The error bar represents the standard deviation of the average values of CE. FIG. 26b shows analysis of capacity usage (SEI Lit, unreacted metallic Li⁰ and reversible Li) under different testing conditions by the TGC method. FIG. 26c shows the ratio of SEI Li⁺ to unreacted metallic Li⁰ based on TGC quantification results. The blue line indicates exponential fitting. FIG. 26d shows total capacity loss as a function of CE. (For unit conversion between milliampere-hours and milligrams of Li, see FIG. 31f) FIG. 26e shows an amount of unreacted metallic Li⁰ measured by the TGC method as a function of CE. FIG. 26f shows calculated SEI Li⁺ amount as a function of Coulombic efficiency.

As shown in FIG. 26a the first-cycle average CEs have a broad range of values, from 17.2% to 97.1%. Representative voltage profiles are shown in FIGS. 31a, b. The total amount of inactive Li is equal to the capacity loss between the plating and stripping processes, displaying a linear relationship with CE (FIG. 26d). The content of metallic Li⁰ was directly measured by the TGC method. Once the amount of unreacted metallic Li⁰ has been determined, the SEI Li⁺ amount can be calculated, as the total amount of inactive Li (known)=unreacted metallic Li⁰ (measured)+SEI Li⁺.

The average capacity utilization under all conditions was quantified by the TGC, as summarized in FIG. 26b. The reversible capacity increases with increasing CE. Interestingly, the unreacted metallic Li⁰ amount increases significantly with the decrease of CE, whereas the SEI Li⁺ amount remains at a constantly low level under all testing conditions. Further analyzing the data, we found to our surprise that the amount of unreacted metallic Li⁰ exhibits a linear relationship with loss of CE (FIG. 26e), and this relationship is almost independent of the testing conditions. This implies that the CE loss is governed by the formation of unreacted metallic Li⁰. Meanwhile, the SEI Li⁺ amount (FIG. 26f), as deduced from the total inactive Li and unreacted metallic Li⁰, remains low and relatively constant under various testing conditions. The ratio of SEI Li⁺ and unreacted metallic)Li⁰ (Li⁺/Li⁰ (FIG. 26c) reveals that the unreacted metallic Li⁰ dominates the content of inactive Li (Li⁺/Li⁰<1) as well as the capacity loss when CE is under about 95% in the first cycle. Once the CE is higher than about 95%, the amount of SEI Li⁺ starts to dominate.

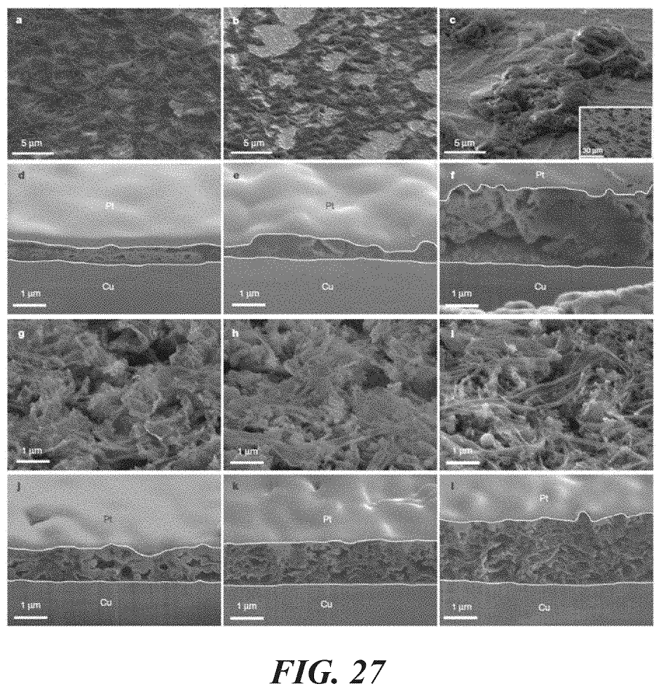

FIG. 27 shows microstructures of inactive Li generated in HCE and CCE imaged by cryo-FIB-SEM. FIGS. 27a-f show results for HCE, FIGS. 27g-l show results for CCE. FIGS. 27a-c, g-i, show a top view of the inactive Li at 52° tilted stage. FIGS. 27 d-f, j-l, show cross-sections obtained by cryo-FIB. Each column represents a different stripping rate: 0.5 mA cm-2 (a, d, g, j); 2.5 mA cm-2 (b, e, h, k); or 5.0 mA cm-2 (c, f, i, l). The ratios of unreacted metallic Li⁰ to total inactive Li, and of SEI Li⁺ to total inactive Li, are further shown in FIGS. 31c, d.

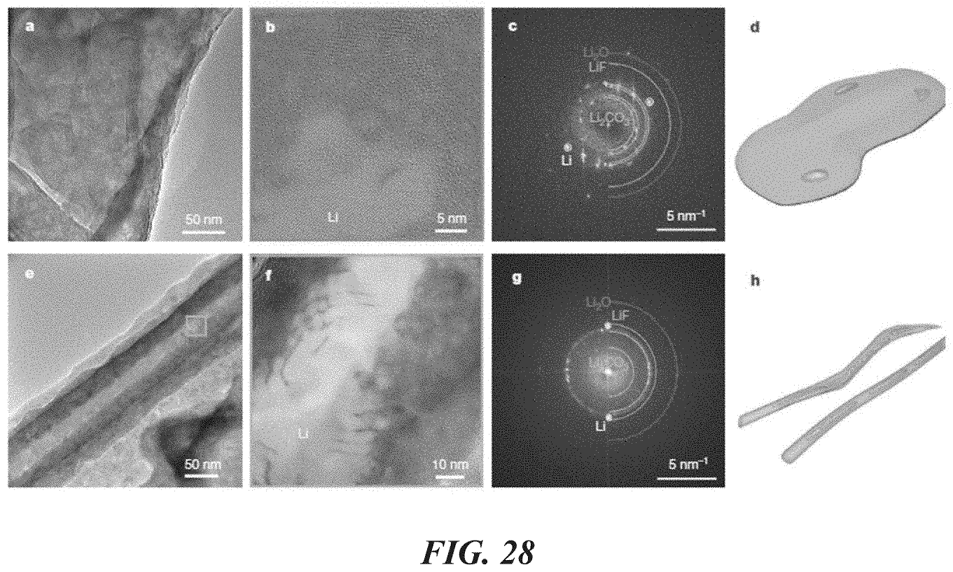

Increasing Li deposition capacity is reported to improve the first-cycle CE. To extend this method under different electrochemical conditions, we performed TGC tests on the CCE with Li plating capacities increased to 2 mAh cm-2, 3 mAh cm-2 and 5 mAh cm-2. FIG. 28 shows nanostructures of inactive Li generated in HCE and CCE imaged by cryo-TEM. FIGS. 28a-c, show results for HCE. FIGS. 28e-g show results for CCE. FIGS. 28a, e, show inactive Li morphology at low magnifications for both electrolytes. FIGS. 28b, f, show a HRTEM that a different amount of metallic Li⁰ is wrapped by SEI in the two types of electrolyte. The highlighted metallic Li⁰ region in green is identified through an inverse FFT process by applying mask filter on the origin FFT patterns. c, g, FFT patterns of corresponding HRTEM indicate the SEI component, which contains crystalline Li₂CO₃, Li₂O, and LiF. d, h, Schematic of inactive Li nanostructure in HCE (d) and CCE (h). A small area of metallic Li0 is embedded in a sheet-like SEI layer for HCE, whereas a large bulk of metallic Li⁰ is isolated in a whisker-like SEI layer in CCE.

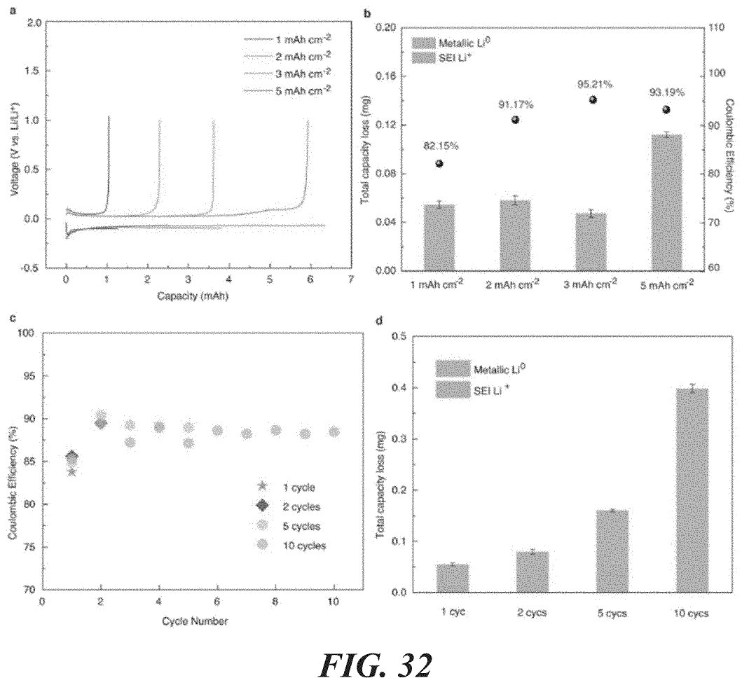

FIG. 32 shows data for TGC analysis of inactive Li formed under extended electrochemical conditions. FIG. 32a shows the voltage profiles of CCE with different deposition capacities at 0.5 mA cm⁻² for 1 mAh cm⁻², 2 mAh cm⁻², 3 mAh cm⁻² and 5 mAh cm⁻². FIG. 32b shows the corresponding TGC analysis of inactive Li with associated capacity loss and CE under different deposition capacities. FIG. 32c shows the cycling performance of CCE in Li∥Cu half-cells at 0.5 mA cm-2 for 1 mAh cm-2. FIG. 32d shows TGC analysis showing Li⁰ and Li⁺ contents with associated capacity loss after one, two, five and ten cycles, respectively. The TGC results (FIGS. 32a, b) show that the SEI Li⁺ amount increases with the extended deposition capacity; the improvement in CE with increased Li deposition capacity is due to the reduction in the amount of unreacted metallic Li⁰. At 3 mAh/cm², the CE reaches 95.21%, while the ratio of SEI Li⁺ to unreacted metallic Li0 is measured to be 1.43, consistent with the above results.

Besides the first cycle, we also investigated the ratio of SEI Li⁺ to unreacted metallic Li0 after multiple cycles (two, five and ten) until the CE is stabilized around 90% in CCE. As shown in FIGS. 32c, d, the Li⁺/Li⁰ ratio after one, two, five and ten cycles remains 0.27, 0.30, 0.27 and 0.34, respectively, indicating that the main capacity loss is from the unreacted metallic Li⁰. The TGC results also reveal that the unreacted metallic Li⁰ amount accumulates during extended cycles, indicating continuous consumption of active Li in Li metal batteries. These experiments, with varying electrolytes, additives, deposition capacities and cycles, all validate the TGC method as a reliable tool in studying the inactive Li.

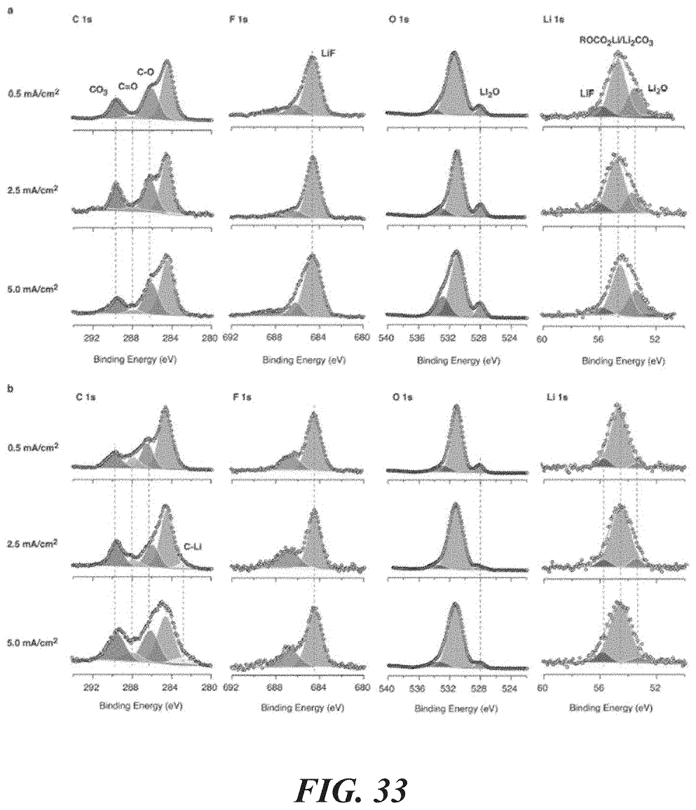

Further examining the SEI components in HCE and CCE by X-ray photoelectron spectroscopy (XPS), we found that stripping rates have negligible impact on the relative contributions from SEI components (see FIGS. 33a, b). The TGC quantification analysis and XPS results establish that the contribution from the SEI Li⁺ to the global content of inactive Li is not as large as commonly believed.

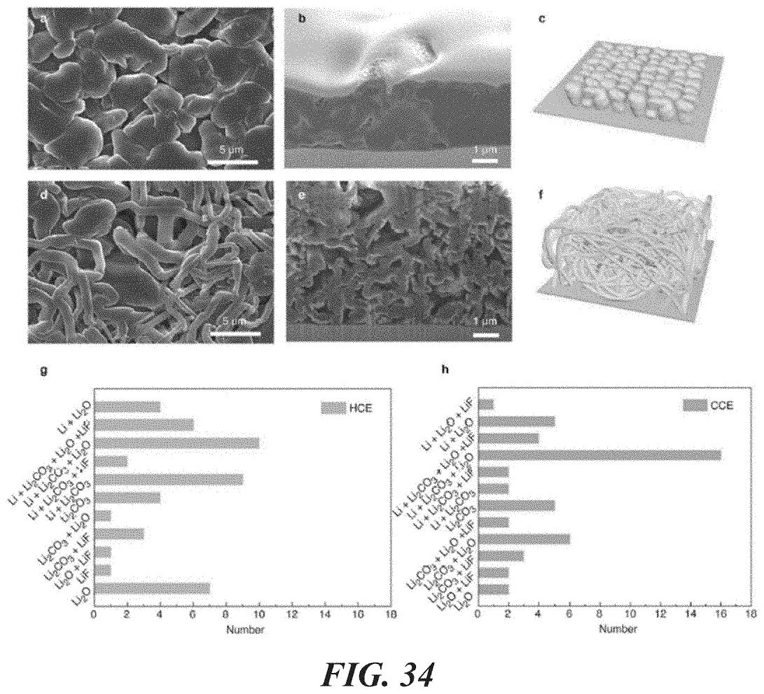

To elucidate the formation mechanism of inactive Li, we use cryogenic focused ion beam-scanning electron microscopy (cryo-FIB-SEM) to explore the microstructures of inactive Li. FIG. 34 shows data for cryo-FIB-SEM and cryo-TEM analysis. FIGS. 34a-c, top view, show cryo-FIB cross-section and schematic of deposited Li in HCE, respectively. The Li deposited in HCE forms large particles with several micrometers in size, with reduced porosity. FIGS. 34d-f top view, show cryo-FIB cross-section and schematic of deposited Li in CCE, respectively. The Li shows a whisker-like morphology with high porosity. All deposited at 0.5 mA cm-2 for 0.5 mAh cm-2. FIG. 34g, Statistics of inactive Li SEI components formed in HCE, as detected at 50 different sample positions by cryo-TEM. FIG. 34h shows statistics of inactive Li SEI components formed in CCE, as detected at 50 different sample positions by cryo-TEM.

HCE and CCE samples under different stripping rates are chosen for the morphological study. Cryogenic protection is critical here, because the highly reactive Li metal is not only sensitive to the electron beam but is also apt to react with the incident Ga ion beam to form a LixGay alloy at room temperature. Completely different morphologies are generated by variations in stripping rates, even though all samples start from the same chunky Li deposits after plating at 0.5 mA cm-2 (FIGS. 34a-c). As the stripping rate increases, the morphology of inactive Li in HCE evolves from uniform sheets to local clusters (FIGS. 27a-c) with a thickness increased from 500 nm to 2 μm (FIGS. 27d-f). For the CCE, the individual whisker-like Li deposits (FIGS. 34d-f) become thinner after stripping (FIGS. 27g-i), but the whole inactive Li layer becomes thicker in cross-section with the increased stripping rates (FIGS. 27j-l), corresponding to the increased loss of CE at high rates. It is worth noting that these residues exhibit poor connection to the current collector, indicating the loss of electronic conductive pathways.

We further used cryogenic transmission electron microscopy (cryo-TEM) to investigate the nanostructure of the inactive Li in HCE and CCE after stripping at 0.5 mA cm-2. Sheet-like inactive Li appears in the HCE sample (FIG. 28a), whereas inactive Li in the CCE retains a whisker-like morphology (FIG. 28e). Based on the (110) lattice plane distance of body-centered cubic Li, the region that contains crystalline metallic Li0 is highlighted in green in the HRTEM images for both electrolytes (FIGS. 28b, f). Compared with the inactive Li obtained from CCE, a much smaller area of metallic Li⁰ component is observed in HCE. This indicates that most of the deposited metallic Li0 in HCE has been successfully stripped, corresponding to the high CE. Whisker-like unreacted metallic Li⁰ up to about 80 nm in length remains in the CCE sample and is well isolated by the surrounding SEI. The SEI components were determined by matching the lattice spacing in HRTEM images with their fast Fourier transform (FFT) patterns (FIGS. 28c, g). The SEI components from more than 50 different sample positions have been analyzed and are provided in FIGS. 34g, h for better statistics.

FIG. 33 shoes XPS analysis of inactive Li SEI formed in CHE and CCE for various stripping rates. FIG. 33a shows an inactive Li formed in HCE. FIG. 33b shows an inactive Li formed in CCE. The stripping rates show negligible impact on SEI components and contents in both electrolytes. Consistent with the XPS results (FIG. 33), Li₂CO₃ and Li₂O constitute the majority of the SEI, which also contains LiF as well as other amorphous organic species for both electrolytes. The above observations from cryo-TEM are summarized in the schematic plot (FIGS. 28d, h), which show the form of inactive Li with two different morphologies at the nanoscale.

Correlating the inactive metallic Li⁰ content with the micro- and nanostructures of inactive Li formed under different conditions, we propose mechanisms for the formation of inactive Li and for the stripping of Li metal. Two processes are involved in the stripping. The first of these is Li⁺ dissolution: under the electric field, metallic Li⁰ is oxidized to Lit, which diffuses through the SEI layers and dissolves into the electrolyte. The second is SEI collapse: when the Li is removed, the SEI simultaneously shrinks and collapses towards the current collector. During these two dynamic processes, we emphasize an ignored but crucial aspect, the structural connection, which is defined as the capability of the active Li to maintain an electronic conductive network. The cryo-FIB-SEM and cryo-TEM images show that inactive Li⁰ was either disconnected from the current collector or encapsulated by the insulating SEI, leading to the loss of structural connection.

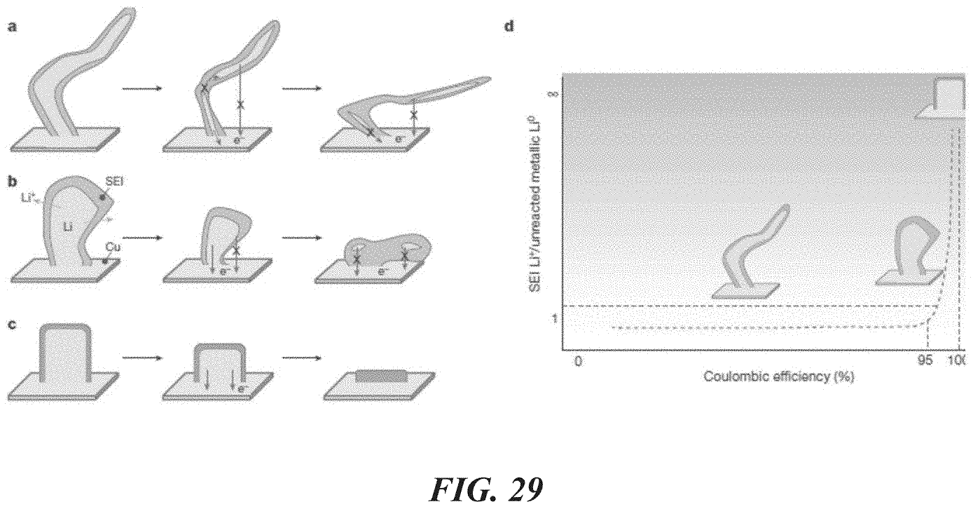

FIG. 29 shows a schematic of inactive Li formation mechanism in different electrolytes, based on TGC quantification, cryo-FIB-SEM and cryo-TEM observation. FIG. 29a shows Li deposits with whisker morphology and high tortuosity are more likely to lose electronic connection and maintain poor structural connection, leaving large amounts of unreacted metallic Li⁰ trapped in SEI. FIG. 29b shows Li deposits with large granular size and less tortuosity tend to maintain a good structural electronic connection, in which only small amounts of metallic Li⁰ are stuck in tortuous SEI edges. FIG. 29c shows an ideal Li deposit should have a columnar microstructure with a large granular size, minimum tortuosity and homogeneous distribution of SEI components, facilitating a complete dissolution of metallic Li⁰. d, A general correlation of morphology of Li deposits, CE and the ratio of SEI Li⁺ to unreacted metallic Li⁰.

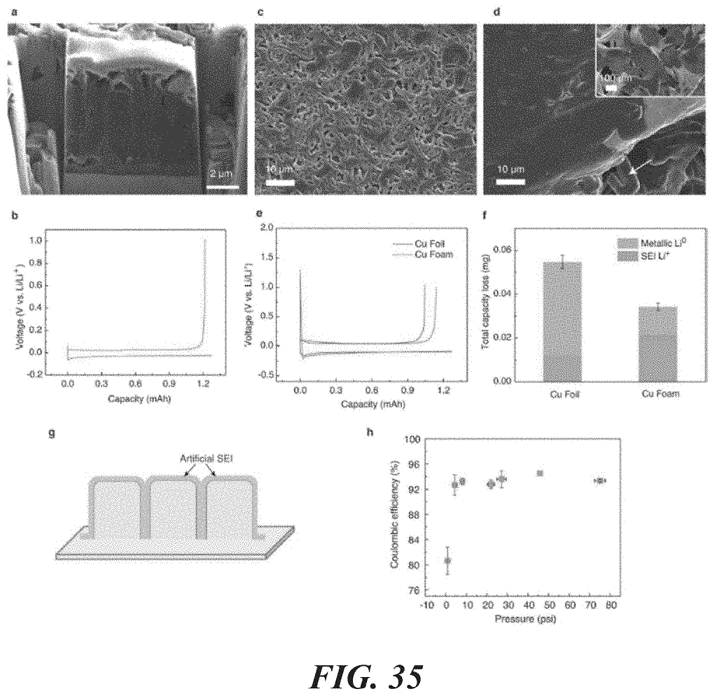

Obviously, for a Li deposit with whisker morphology and large tortuosity (FIG. 29a, taking the Li deposits formed in CCE as an example), the undesired microstructure can easily produce both ways of losing structural connection, leaving more unreacted metallic Li⁰ during the stripping process. In contrast, dense Li with chunky morphology and low tortuosity (FIG. 29b, from HCE) has bulk integrity to maintain its structural connection and intimate contact with the current collector, resulting in a reduced presence of unreacted metallic Li⁰ and high CE. This is further evidenced by an advanced electrolyte with columnar microstructure and minimum tortuosity, which can deliver a first-cycle CE as high as 96.2% (FIGS. 35a, b).

Based on the above observations and discussion, strategies to improve CE are shown in FIG. 35. FIG. 35a shows a cross-sectional morphology of Li deposits generated in an advanced electrolyte developed by General Motors (GM), showing a columnar structure. FIG. 35b shows the GM electrolyte delivers a first-cycle CE of 96.2%, plating at 0.5 mA cm-2 for 1 mAh cm-2, stripping at 0.5 mA cm-2 to 1 V. c-f, 3D current collector. FIG. 35c shows a SEM image of Li deposits on Cu foil. FIG. 35d shows a SEM image of Li deposits on Cu foam. Both were deposited at 0.5 mA cm-2 for 1 mAh cm-2 in CCE. FIG. 35e shows a representative first-cycle voltage profiles of Cu foil and Cu foam, plating at 0.5 mA cm-2 for 1 mAh cm-2, stripping at 0.5 mA cm-2 to 1 V in CCE. FIG. 35f shows a TGC quantification of inactive Li for Cu foil and Cu foam samples. FIG. 35g shows a schematic of an ideal artificial SEI design. The polymer-based artificial SEI should be chemically stable against Li metal and mechanically elastic enough to accommodate the volume and shape change. Meanwhile, the edges of the artificial SEI should be fixed to the Li metal or the current collector, preventing the electrolyte from diffusing and making contact with fresh Li metal. The flexible polymer SEI thus can accommodate expansion and shrinkage during repeated Li plating and stripping. In this way, no Li will be consumed to form SEI during extended cycles, and we can realize anode-free Li metal batteries. FIG. 35f shows an influence of pressure on Li plating/stripping. The results are from the HCE, at 0.5 mA cm-2 for 1 mAh cm-2, using a load cell. At each condition, two load cells were measured. The error bars indicate the standard deviation.

An ideal architecture of deposited Li would promote structural connection and mitigate inactive Li formation, especially the formation of unreacted metallic Li⁰. The ideal architecture includes the following. (1) The Li deposits should retain a columnar microstructure with a large granular size and minimum tortuosity, to minimize the unreacted metallic Li⁰ residue (FIGS. 29c, d). (2) The SEI should be both chemically and spatially homogeneous so that uniform Li′ dissolution occurs. It should be mechanically elastic enough to accommodate the volume change. The SEI could be refilled during extended cycles, as schematized in FIG. 35g. Using advanced electrolytes and artificial SEI may help to meet these requirements, while three-dimensional (3D) hosts that maintain electronic pathway and low tortuosity can contribute to constructing a durable structural connection and guiding the Li plating and stripping. To test this hypothesis, we compared 2D Cu foil and 3D Cu foam as the current collectors (FIGS. 35c, d). The initial CE of 2D Cu foil and 3D Cu foam is 82% and 90%, respectively (FIG. 35e). The increased CE in the latter is attributed to the reduced amount of unreacted metallic Li⁰ (FIG. 35f), despite the fact that the amount of SEI Li⁺ increases from 21.5% to 62.7% owing to the higher surface area of 3D Cu foam. Therefore, although the 3D current collector helps in maintaining a good electronic conductive network, it is necessary to control its surface properties to minimize SEI formation. The structural connection can be further enforced by applying external pressure. Slight stacking pressure can improve cycling performance. In our proposed model, we believe that pressure promotes structural collapse towards the current collector, thus leading to better structural connection which mitigates the generation of unreacted metallic Li⁰. We found the critical pressure in maintaining good structural connection to be as low as about 5 psi, which should not damage any SEI (FIG. 35h). A fast stripping rate could accelerate the Li⁺ dissolution but may destroy the structural connection, because Li at the tip of column or whiskers could fail to keep pace with the rapid dynamic. Overall, the tools established here can be universally extended to examine various battery chemistries under different conditions, with the aim of developing a better battery that is energy-dense and safe.

Methods

Electrochemical testing. CE was measured in Li∥Cu coin cells: Li metal (1 mm thick, 0.5 inch in diameter), two pieces of separators (Celgard) and Cu foil (0.5 inch in diameter) were sandwiched in CR2032 coin cells with a spacer and a spring, and crimped inside an Ar-filled glovebox. A 50 μl amount of the electrolyte was added in each cell. HCE consists of 4 M LiFSI (battery grade; Oakwook Products, Inc.)+2 M LiTFSI (battery grade; Solvay) in DME (anhydrous, >99.5%; BASF). CCE consists of 1 M LiPF6 (battery grade, BASF) in EC/EMC (battery grade, BASF) (3:7 by weight) with 2 wt % of vinylene carbonate (battery grade, BASF). CCE+Cs+ contains 50 mM of CsPF6 (Synquest Laboratory). CCE+FEC contains 10 wt % of FEC (anhydrous, >99%, Sigma-Aldrich). DOL (anhydrous, >99.5%) and LiNO3 were purchased from Sigma-Aldrich. Cells for TGC are plating at 0.5 mA cm⁻² for 1 mAh cm⁻² and stripping at various rates (0.5 mA cm⁻², 2.5 mA cm⁻² and 5 mA cm⁻²) to 1 V, unless otherwise specified.

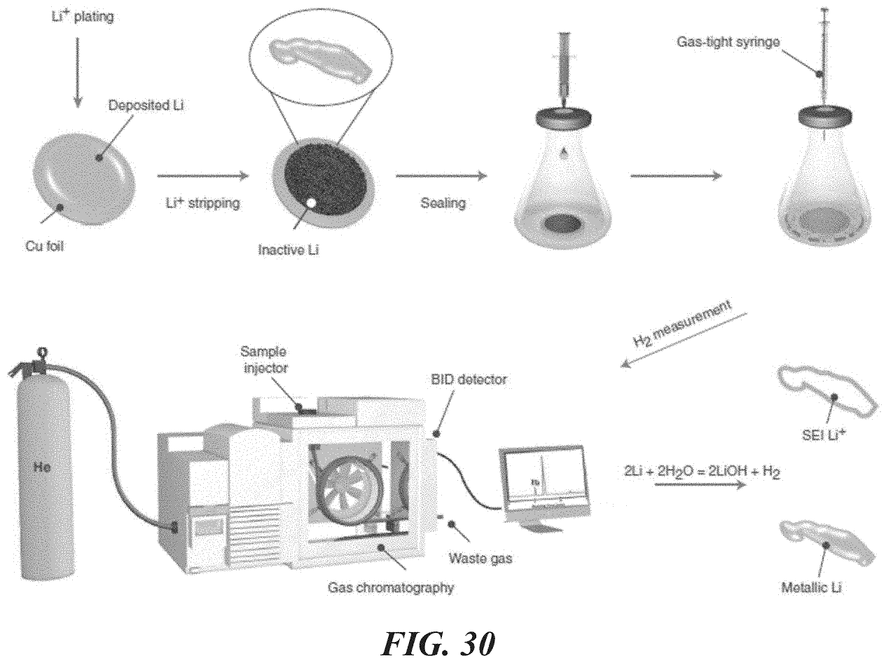

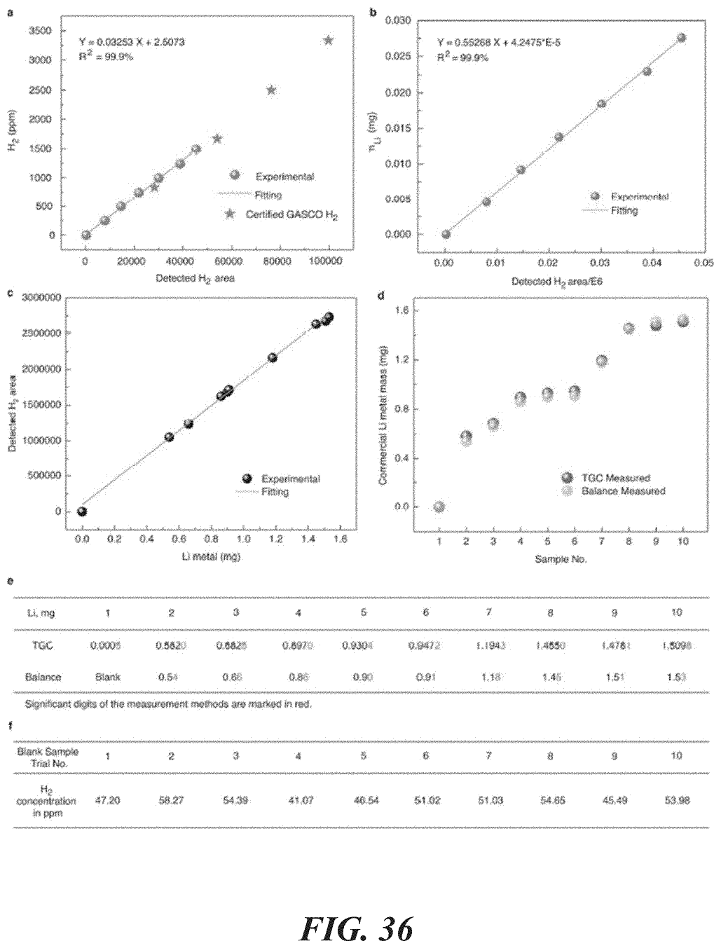

Titration-gas chromatography. FIG. 30. Shows a schematic working principle of the TGC method. By combining H₂O titration on an inactive Li sample and H₂ quantification by GC, the amount of metallic Li⁰ is calculated based on the chemical reaction 2Li+2H₂O→2LiOH+H₂↑ demonstrates the typical processes of the TGC method for the inactive Li quantification, including the following six main steps. (1) After plating and stripping, the Li∥Cu coin cell was disassembled in an Ar-filled glovebox. (2) While still in the glovebox, both the Cu foil and separator on the Cu foil side were harvested without washing and sealed in a container with an inside pressure of 1 atm by a rubber septum which is stable against water. (3) After transferring the sample container out of the glovebox, we injected 0.5 ml of H₂O into the container to react with the inactive Li completely. (4) A gas-tight syringe was used to transfer 30 μl of the resultant gas from the container into the GC system. (5) The amount of H₂ was measured by the GC. (6) The content of the metallic Li⁰ was determined by converting the corresponding H₂ amount according to a pre-established standard calibration curve (FIG. 36b). All the processes minimize the potential damage and contamination during sample transfer, to obtain reliable results.

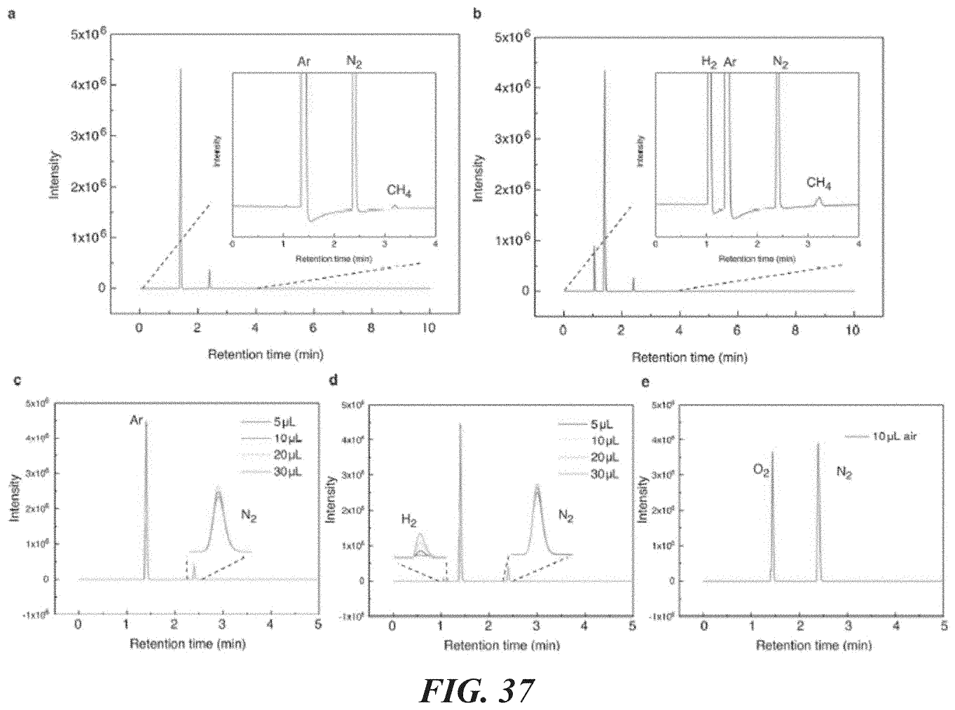

FIG. 37 shoes GC chromatogram and N₂ interference analysis. FIG. 37a shows a GC chromatogram of the background gas from glovebox. FIG. 37b shows a GC chromatogram of gases with H₂ after H₂O titration on metallic Li⁰. FIG. 37c shows a glovebox background gas measurements with various sampling amounts. The N₂ amounts remain at the same level with various injection amounts, indicating the N₂ does not exist in the reaction container. FIG. 37d shows a container gas measurements with various sampling amounts after the H₂O titration. The N₂ amounts still remain identical with different injection amounts, whereas the H₂ amounts increase in proportion to the increment of injection amounts, indicating that the N₂ does not originally exist in the reaction container but comes from the gas sampling process, and thus will not have any chemical reactions with the inactive Li samples; the H₂ quantification is not influenced by the injection sampling process. FIG. 37e shows a GC chromatogram of 10 μl of air.

In the GC column, the stationary phase has a different affinity with different species, so that gas species can be differentiated by retention time. FIG. 37a shows the GC chromatograms of background gases from a well-sealed empty container in the Ar-filled glovebox. The peaks at 1.45 min, 2.42 min and 3.21 min represent Ar, N₂ and CH₄, respectively. When an H₂O titration process is applied to a small piece of pure Li metal, H₂ will be generated. The H₂ characteristic peak appears at 1.05 min, as shown in FIG. 37b.

Source of N₂ in the gas chromatograms. Note that N₂ detected from the GC comes from the gas sampling process, instead of existing in the reaction container. As schematized in the TGC process in FIG. 30, the inactive Li samples were loaded and sealed into the reaction container in an Ar-filled and N₂-free glovebox. After the samples were taken out of the glovebox, 0.5 ml of pure H₂O was injected into the container and reacted with the inactive Li sample. This is an air-free process. A gas-tight syringe was then used to take the gas sample for GC injection and measurement. There is a small amount of air left in the needle space of the gas-tight syringe. Moreover, in the GC injection process, when the needle breaks the septum, a tiny amount of air might be introduced into the GC column. Even though the air peak is inevitable for the injection gas sampling method, the inactive Li samples have indeed all been reacted in advance and were never exposed to N₂.

We carried out the following tests to demonstrate that the N₂ comes from the air during sampling and that the presence of air has negligible impact on the inactive Li (H₂) quantification. First, we measured the gas in the blank container without any inactive Li, which has been well sealed in the Ar-filled glovebox. If the N₂ comes from the reaction container, the intensity of the N₂ peaks will vary proportionally to the injected gas amount into the GC. We took different amounts of gas sample from the blank container and performed GC measurement. As shown in FIG. 37c, the N₂ peak intensities remain almost identical for injection amounts varying from 5 to 30 μl. The same result was obtained when H₂O titration was performed on inactive Li. The measured H₂ content increase as a function of injected gas amount while the N₂ content remains almost constant (FIG. 37d). Noting that the reaction container is sealed in the Ar-filled glovebox, the Ar peak is saturated even if only 5 μl of sample gas is injected and remains unchanged in all measurements. The invariability of N₂ peaks is not because of saturation in the previous measurements, since the intensity of the N₂ peak increases significantly after purposely injecting 10 μl of air (FIG. 37e). Therefore, we have confirmed that the N₂ comes from the injection sampling process and it will not have any chemical reaction with the inactive Li samples. Moreover, the H₂ quantification is not influenced by the injection sampling process.

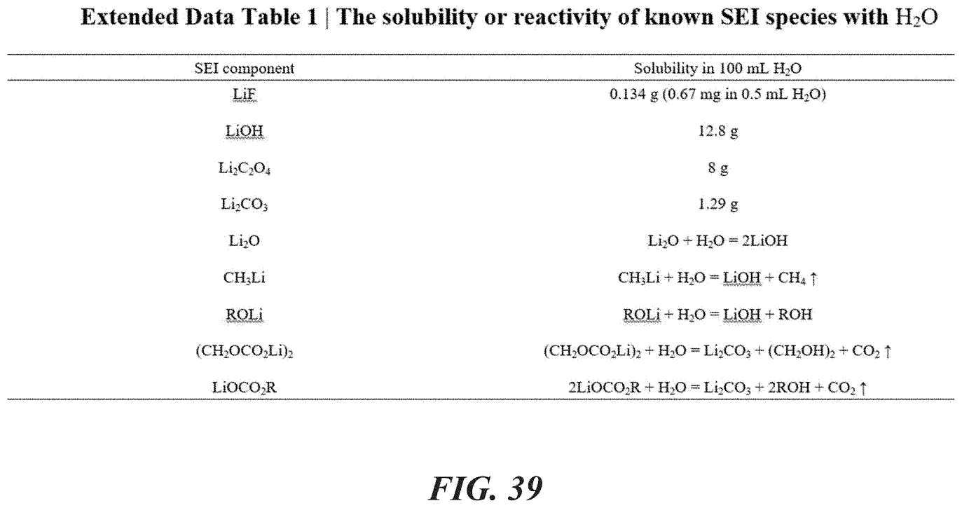

Possible existence of LiH. Besides the SEI species listed in table of FIG. 39, there have been mixed reports regarding the existence of LiH in Li metal electrodes. There are two possible scenarios in which LiH may exist in the Li metal electrodes: (1) LiH may exist within the SEI as an electrochemical reduction product at excessively negative potentials^{21,22}; (2) LiH may largely exist in the bulk electrode as mossy dendrites²⁰. To examine the possible influence from LiH in SEI, we repeatedly polarized the current collectors above 0 V, so that only SEI forms without metallic Li⁰ deposition.

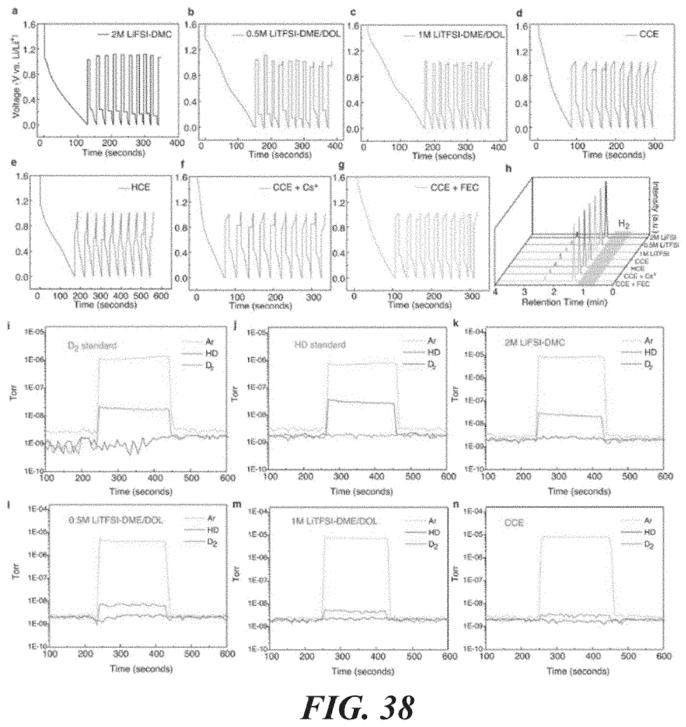

FIG. 38 shows analysis of possible LiH presence in inactive Li. FIGS. a-h show possible influence from LiH in SEI. FIGS. a-g show the voltage profiles of SEI formation between 0 V and 1 V at 0.1 mA for ten cycles in 2 M LiFSI-DMC (a), 0.5 M LiTFSI-DME/DOL (b), 1 M LiTFSI-DME/DOL (c), CCE (d), HCE (e), CCE+Cs+(f) and CCE+FEC (g). After the SEI formation, we performed TGC measurements on the current collectors with SEI. h, TGC results of the seven types of electrolytes. No H₂ can be detected from any of them, indicating no LiH presence in the SEI of the systems studied. FIGS. 38i-n show possible influence from LiH in bulk inactive Li. To differentiate the two species, we substitute the titration solution with D₂O instead of H₂O. The D₂O reacts with LiH and metallic Li⁰ to produce HD and D₂, respectively. RGA can effectively distinguish between HD (relative molecular mass 3) and D₂ (relative molecular mass 4) by partial pressure analysis. FIG. 38i shows the D₂ standard from the reaction between commercial pure Li metal and D₂O. FIG. 38j shows the HD standard from the reaction between commercial LiH powder and D₂O. FIGS. 38k-n show analysis of gaseous products from reactions between D₂O and inactive Li forming in 2 M LiFSI-DMC (k), 0.5 M LiTFSI-DME/DOL (l), 1 M LiTFSI-DME/DOL (m) and CCE (n).

For the electrolytes investigated in this work, after such cyclic polarizations between 0 V and 1 V for ten cycles, the TGC detected no H₂ from all SEI-water reactions (FIGS. 38a-h), indicating that LiH does not exist in the SEIs. To examine the possible influence from LiH in bulk inactive Li, we changed the titration solution from H₂O to D₂O, which can distinguish LiH and metallic Li⁰ by producing HD and D₂, respectively, based on the following reactions: (1) LiH+D₂O=LiOD+HD↑; (2) 2Li+2D₂O=2LiOD+D₂↑. Differentiating HD and D₂ was then achieved based on partial pressure analysis by residual gas analyzer (RGA). From the RGA results (FIGS. 38i-n), we confirmed that LiH does not exist in the bulk inactive Li generated by the electrolyte systems of low CE. The exclusion of LiH from either SEI or bulk inactive Li confirms that the conclusions drawn from the TGC analysis should be reliable and free of interference from possible LiH species.

Calibration. The H₂ concentration was calibrated and measured using a Shimadzu GC-2010 Plus Tracera equipped with a BID detector. Helium (99.9999%) was used as the carrier gas. Split temperature was kept at 200° C. with a split ratio of 2.5 (split vent flow: 20.58 ml min⁻¹, column gas flow: 8.22 ml min⁻¹, purge flow: 0.5 ml min⁻¹). Column temperature (RT-Msieve 5A, 0.53 mm) was kept at 40° C. A BID detector was kept at 235° C., and BID detector gas flow rate was 50 ml min⁻¹. All calibration and sample gases were immediately collected via a 50 μl Gastight Hamilton syringe before injection. For calibration of H₂ concentration, 1,500 ppm of H₂ gas was produced by reacting high-purity sodium with DI water in a septum sealed glass vial. We collected 5 μl, 10 μl, 15 μl, 20 μl, 25 μl and 30 μl of the H₂ gas produced, corresponding to 250 ppm, 500 ppm, 750 ppm, 1,000 ppm, 1,250 ppm and 1,500 ppm, respectively, and injected them into the GC. The calibration curve was plotted and fitted with H₂ concentration versus H₂ peak area as measured by the GC. The as-established H₂ calibration curve (H_{2,ppm} versus detected H₂ area) and equation are shown in FIG. 36a. To acquire the exact number of H₂ molecules within the container, the H₂ concentration calibration curve was converted to a calibration curve in terms of the mole number of H₂ as a function of detected area based on the following two conditions: (1) 1 ppm=4.08×10⁻⁸ mmol ml⁻¹ (1 atm, 298 K); (2) container volume (30±0.5 ml).

The mole number of H₂ calibration curve established a direct relationship between H₂ area reported by the GC software and the number of H₂ molecules in the fixed TGC set-up, making the following inactive Li measurement independent of slight pressure change. Based on the chemical reaction 2Li+2H₂O→2LiOH+H₂↑, the standard calibration curve and the equation for Li metal mass (m_{Li}) as a function of the detected H₂ area are obtained and shown in FIG. 36b.

Validation of the GC measurement. FIG. 36 shows data for TGC calibration and LOD/LOQ analysis. FIG. 36a shows H₂ concentration in ppm calibration curve as a function of detected H₂ area and verification with certified GSCO H₂ calibration gas. FIG. 36b shoes converted metallic Li⁰ mass calibration curve as a function of detected H₂ area. FIG. 36c shows nine pieces of Li metal with known mass were tested using the TGC set-up. The strongly linear relationship with detected H₂ area indicates the feasibility of this method. FIG. 36d shows a comparison between the balance-measured mass and TGC-quantified mass of the commercial Li metal pieces. FIG. 36e shoes a numerical comparison between the balance-measured mass and TGC-quantified mass of the commercial Li metal pieces. As the accuracy of the balance is two orders of magnitude lower than the TGC (10-5 g versus 10-7 g), the differentials should mainly come from the balance. FIG. 36f shows H₂ concentration in the blank samples measured for LOD/LOQ analysis. A total of 10 measurements were taken for the LOD/LOQ calculation.

(1) The H₂ concentration in ppm as a function of GC detected H₂ area (FIG. 36a) was verified by using the certified GASCO H₂ calibration test gas. (2) We then used commercial Li metal of known mass to verify the relationship established for mu versus detected H₂ area (FIG. 36b). We carefully weighed nine pieces of commercial Li metal with mass ranging from 0.54 mg to 1.53 mg in the Ar-filled glovebox with a five-digit balance (10⁻⁵ g) and then performed the TGC measurement. The detected H₂ area as a function of the Li metal mass from the nine pieces of Li metal is shown in FIG. 36c. The result shows that the mass of Li metal is linearly related (R²=99.8%) to the detected H₂ area, indicating the validity of the TGC system for quantifying metallic Li⁰. In reverse, we calculated the Li metal mass from the detected H₂ area using the relationship of mu versus detected H₂ area. The TGC-measured and balance-measured Li metal masses are compared in FIG. 36d. The exact values of TGC-measured and balance-measured Li metal masses are listed in FIG. 36e. The negligible differences between the TGC quantification and balance measurement indicate the validity and accuracy of the TGC method. The significant digit of the balance is 0.01 mg (10⁻⁵ g), as marked in red in FIG. 36e, whereas that of the TGC is 0.0001 mg (0.1 μg, 10⁻⁷ g), which has been demonstrated in the limit of detection/limit of quantification (LOD/LOQ) analysis. Thus, the minimal difference between the two quantification methods is mainly ascribed to the inaccuracy of the balance, which has a precision two orders of magnitude smaller than the TGC.

LOD/LOQ analysis. The concentration of hydrogen in the air is 0.000053%. To get the LOD/LOQ values, 30 μl of the air sample was injected into GC by the same gas-tight syringe as used for the hydrogen measurement and repeated for a total of 10 times. The results are listed in FIG. 36f Based on the definition of LOD/LOQ, the calculated LOD/LOQ from the table is 16.44 ppm and 49.81 ppm, respectively, corresponding to 0.28 μg and 0.84 μg of metallic Li⁰ in the designed TGC system.

Inactive Li sample measurement. After stripping under various conditions, Li∥Cu cells were disassembled inside an Ar-filled glovebox (H₂O<0.5 ppm). The Cu foil and separator near the Cu foil side with inactive Li residue on top were placed into a 30 ml container without washing. The container was sealed by a rubber septum and further capped by a stainless-steel/copper ring for safety and to minimize the deformation of the rubber septum when gas was generated later. The internal pressure of the sealed container was adjusted to 1 atm by connecting the container and glovebox environment (0 mbar) with an open-ended syringe needle. After transferring the sealed container out of the glovebox, 0.5 ml of water was injected into the container, allowing complete reaction of inactive Li residue with water. An excess amount of H₂O was added to react with all the inactive metallic Li⁰, leading to complete conversion to the H₂ products. The Cu foil became shiny and the separator normally became clean when reactions finished, indicating a complete reaction of the inactive Li with H₂O. The as-generated gases were then well dispersed and mixed by shaking the container to prevent H₂ accumulation on top of the container. Then a gas-tight syringe was used to quickly take 30 μl of the well-mixed gas and to inject it into the GC for H₂ measurement.

FIG. 31 shows data for TGC analysis. FIGS. 31a, b show representative voltage profiles of Li∥Cu cells in (a) HCE and CCE, plating at 0.5 mA cm⁻² for 1 mAh cm⁻², stripping to 1 V at 0.5 mA cm⁻², 2.5 mA cm⁻² and 5.0 mA cm⁻² (voltage profiles below 0 V represent the plating process, while those above 0 V represent the stripping process); (b) 2 M LiFSI-DMC, 0.5 M LiTFSI-DME/DOL, 1 M LiTFSI-DME/DOL, 1 M LiTFSI-DME/DOL+2% LiNO₃, CCE+Cs+ and CCE+FEC, plating at 0.5 mA cm⁻² for 1 mAh cm⁻², stripping to 1 V at 0.5 mA cm⁻². FIG. 32c shows the isolated metallic Li⁰ percentage in total capacity loss (Li⁰/Li⁰+Li⁺). FIG. 32d shows SEI Li⁺ percentage in total capacity loss (Li⁺/Li⁰+Li⁺). FIG. 31e shows measured H₂ The GC-measured H₂ areas as a function of cell CE are shown in FIG. 31e. The conversion between mAh and mg of Li is shown in FIG. 31f.

Safety considerations. Li is electrochemically inactive, but chemically hyperactive due to the high surface areas which may lead to serious potential safety hazards. Inactive Li quantification using the TGC method should be done carefully, taking the following aspects into consideration:

(1) The proper amount of inactive Li for TGC measurement. The minimum amount of inactive metallic Li that has been measured is as low as 1 (˜0.004 mAh). The maximum amount measured in the present work is ˜1.6 mg, corresponding to ˜6 mAh. It is generally preferred to reduce the amount of inactive Li sample, as the GC with an advanced H₂ detector can be very sensitive (1 ppm). The greater the amount of H₂ generated, the more dangerous it could be.

(2) The reaction container must be completely sealed inside the Ar-filled glovebox before it is taken out, to avoid O2 and moisture entering the container. Moisture in air influences the measurement accuracy, and O2 may lead to an explosion when a large amount of water reacts with inactive Li.

(3) Stainless steel/copper rings should be used to minimize the deformation of the rubber septum when H₂ is generated inside the reaction container after water titration, and to prevent potential explosion due to the increased internal pressure.

(4) Waste gas in the container after TGC measurement should be disposed of in a fume hood to avoid regional H₂ accumulation which can lead to an explosion (explosive limits of H₂ in air range from about 18% to 60%; the flammable limits are 4-75%).

Cryogenic focused ion beam scanning electron microscopy. The inactive Li samples on Cu foil were disassembled and washed with anhydrous DME (for HCE) or DMC (for CCE) in the Ar-filled glovebox. The samples were mounted on the SEM sample container in the glovebox, then transferred to a FEI Helios NanoLab Dualbeam. Platinum was deposited for surface protection from the ion beam: 100 nm of Pt was deposited using the electron beam at 5 kV, 0.8 nA; 300 nm of Pt was deposited using the ion beam at 30 kV, 0.1 nA. The stage was cooled with liquid nitrogen to −180° C. or below. Sample cross-sections were exposed using a 1 nA ion beam current and 100 ns dwell time, and cleaned twice at 0.5 nA and 0.1 nA, respectively. SEM images were taken with an Everhart-Thornley Detector (ETD) at 5 kV.

Cryogenic transmission electron microscopy. The cryo-TEM sample for HCE was directly deposited and stripped on a lacey carbon grid in the Li∥Cu half-cell. The sample for CCE was prepared by peeling the inactive Li from Cu foil cycled in the half-cell, and then depositing it onto the same type of TEM grid. Both half-cells were plated at 0.5 mA cm⁻² for 2 hours and then stripped to 1 V at the same rate. Both TEM samples were slightly rinsed with DME/DMC in the Ar-filled glovebox to remove trace Li salt. Once dry, the samples were sealed in airtight bags and plunged directly into a bath of liquid nitrogen. The airtight bags were then cut and the TEM grids were immediately immersed in liquid nitrogen. Then the grids were mounted onto a TEM cryo-holder (Gatan) via a cryo-transfer station. In short, the whole TEM sample preparation and transfer process prevents any contact of Li metal with the air at room temperature. TEM characterizations were carried out on JEOL JEM-ARM300CF at 300 kV and JEM-2100F at 200 kV. HRTEM images were taken at a magnification of ×500,000 with a Gatan OneView Camera (full 4,000×4,000 pixel resolution) when the temperature of samples reached about 100 K. The FFT pattern and inverse FFT image after mask filtering were analyzed with DigitalMicrograph software.

X-ray photoelectron spectroscopy. After a plating/stripping process, cells were disassembled in an Ar-filled glovebox with H₂O<0.5 ppm Cu foils with inactive Li residue were gently and thoroughly rinsed by DME (for HCE) and DMC (for CCE) to remove residual surface Li salts. The rinsed electrodes were sealed in an airtight stainless-steel container and transferred into the glovebox connected to the XPS chamber. XPS was performed with a Kratos AXIS Supra, with the Al anode source operated at 15 kV. The chamber pressure was <10⁻⁸ torr during all measurements. All XPS measurements were collected with a spot size 300 μm by 700 μm with a charger neutralizer during acquisition. Survey scans were collected with a 1.0 eV step size, followed by high-resolution scans collected with a step size of 0.05 eV. Fittings of the XPS spectra were performed with CasaXPS software (version 2.3.15, Casa Software Ltd) to estimate the atomic compositions and chemical species. All species (Li 1s, F 1s, O 1s and C 1s) were fitted using a Shirley type background. High-resolution spectra were calibrated using the C is peak at 284.6 eV. The peak positions and areas were optimized by a Levenberg-Marquardt least-squares algorithm using 70% Gaussian and 30% Lorentzian line shapes. Quantification was based on relative sensitivity factors. The curve fit for the core peaks was obtained using a minimum number of components to fit the experimental curves.

Residual gas analyzer. To exclude the potential influence on TGC (H₂) quantification from LiH, which may exist in the bulk electrode as mossy dendrite, we designed an alternative approach to distinguish between LiH and metallic Li⁰ by changing the titration solution from H₂O to D₂O, which reacts with LiH and Li to produce HD and D₂, respectively, followed by differentiating between HD and D₂ based on partial pressure analysis by RGA. The base pressure in the vacuum chamber is ˜8×10⁻⁸ torr. The gas mixtures were introduced into the chamber using an MKS pressure/flow control valve controlled by a computer. The partial pressures of gases in the system were measured using an SRS RGA with a detection limit down to 10⁻¹¹ torr. The turbo pump and backing pump used in this vacuum system were specially designed for handling highly corrosive gases. This setup provides a wide-range partial pressure control (10⁻¹¹ torr to 10⁻⁴ torr) and allow the identification of the different gas molecules including hydrogen isotopes present in the system under high vacuum conditions. Before measuring each sample, the whole system was pumped down to high vacuum (10⁻⁸ torr) to minimize the possibility of contamination.

Quantification of Lithium Inventory Loss in Micro Silicon Anode

The commercialization of silicon as an anode material for lithium-ion batteries has been largely impeded by its severe volume changes during cell operation, causing continuous loss of Li inventory. As such, it is vital to understand and quantify the sources of capacity fade in order to design effective mitigation strategies. Herein, we design a method based on TGC to reveal a non-linear volume expansion in μSi anode during the lithiation process. The severe volume expansion towards the end of lithiation leads to accelerated SEI formation and conductive pathway loss, resulting in a large amount of trapped Li—Si alloy accumulation. The TGC method is also applied to investigate μSi anodes with two different binders: Sodium Carboxymethyl Cellulose (CMC-Na) and Polyacrylic Acid (PAA). The primary reason for capacity loss for anode with CMC-Na binder is trapped Li—Si alloy, which can be mitigated by using more robust PAA binder. The SoC control principle is also investigated in μSi-LFP full cells with both binders by tuning the N/P ratios (1.5-3). The results indicate binder robustness is crucial for mitigating the trapped Li—Si alloy accumulation in μSi anode.

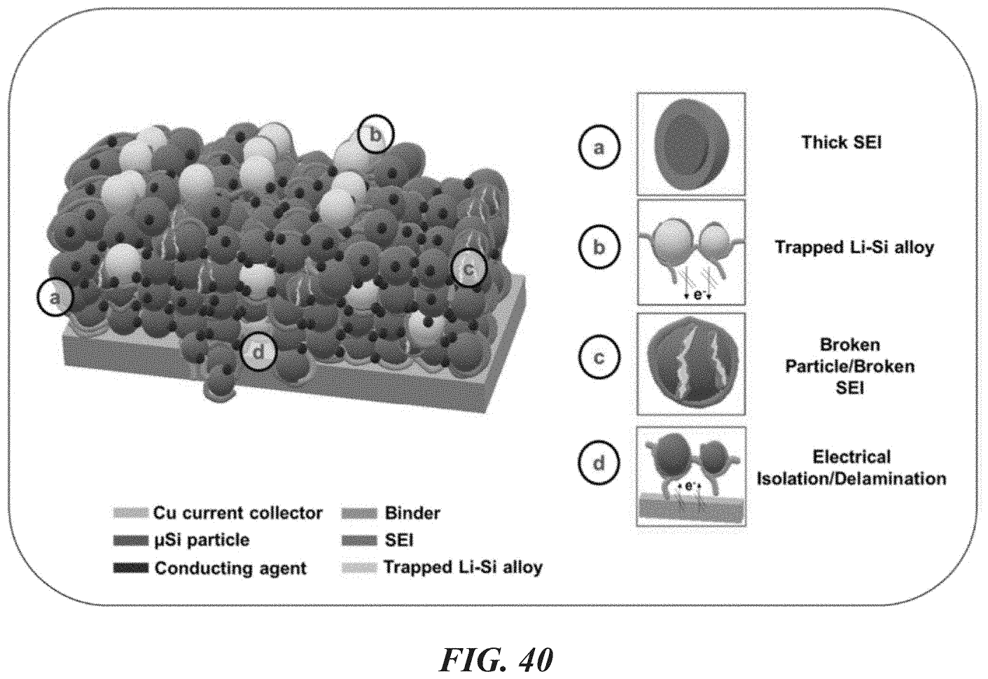

Alloy-based materials are increasingly used as anode candidates due to its potential to increase energy densities of LIBs. Among them, silicon stands out as a material because of its low cost and relative abundance within the earth's crust (second most abundant element by volume of earth's crust). In addition, silicon also possesses high theoretical specific capacity (3579 mAh/g) and low working potential (0.4 V vs. Li/Li⁺), which are key features to enable high-energy density LIBs. However, major roadblocks toward commercialization of silicon-based anodes include its severe volume expansion during electrochemical cycling, which leads to continuous SEI formation and Li inventory losses. At the particle level, the stress-strain effects caused by the severe volume expansion induces cracks within larger particles, exposing new surfaces to the electrolyte, resulting in decomposition to form additional SEI. Previous studies have shown a strong dependence on particle size in the propagation of cracks, where a small critical diameter (Dc˜150 nm) was found to be essential in mitigating crack propagation. On the electrode scale, severe volume expansion leads to the loss of electrical contact between the active material and conductive network, resulting in an accumulation of trapped Li—Si alloy within the electrode matrix. FIG. 40 summarizes the major challenges of pSi anode for LIBs.

In the past, various characterization tools to study the failure mechanisms in silicon anodes can be used. Ex-situ 7Li MAS NMR has been applied to show that most Li losses are found on the surface of the nano-silicon particle in the form of SEI products. A semi-quantitative Acoustic Emission technique (AE) has been employed to understand the nature of crack formation and also the time of occurrence of crack formation and propagation during the lithiation and delithiation processes in pSi anode. Most emission signals were detected in the first lithiation cycle, corresponding to new surface cracking in the initial lithiation process. X-Ray micro-computed tomography (X-Ray micro-CT) has been used to visualize the pSi particle expansion, crack propagation, and pore formation due to gas production from side reactions caused by the electrolyte decomposition. Most of these studies have focused on the qualitative or semi-quantitative description of SEI and its properties. Little attention was given to the Li inventory loss quantification at the pSi anode, especially in the context of a full cell with limited Li source. Most reported literature conducted studies on half-cells using an infinite Li source, making quantification of Li losses challenging. Moreover, most advanced characterization tools are limited to pure silicon systems such as silicon thin films, silicon nanowires/nanorods, etc. It is vital to develop quantification tools to analyze practical electrode systems where inactive components such as binders and conductive agents present can affect Li inventory losses.

To reduce the Li inventory loss in silicon anodes, several mitigation strategies have been previously proposed. These methods can be mainly classified into three broad categories: morphological designs, electrolyte additives, and novel binders. Different silicon morphologies such as nano-wires, nano-layers, core-shell model, and yolk-shell model have been utilized to reduce the net volume expansion-contraction stress induced by distributing it throughout the structure. As for electrolyte additives, FEC and vinylene carbonate (VC) have been reported to form a robust passivating SEI layer consisting of LiF, Li₂O, Li₂CO₃, which improved the cycle stability of silicon anode. Apart from carbonate ester solvents, additives such as succinic anhydride (SA), tetraethoxysilane, and (2-cyanoethyl)-triethoxysilane (TEOS and TEOSCN) have also been reported. In exploring novel binders, co-polymer binders like alginate binder, cross-linking type such as polyacrylic acid-carboxymethyl cellulose (PAA-CMC), self-healing polymeric binders such as Meldrum's acid-based functional binder, conducting polymeric binders such as PEFM functional binder have been reported. These novel binders have been shown to reduce the capacity fade upon cycling by maintaining sufficient conductive network within the entire electrode. While different characterization techniques have been performed in these reports, they still largely focused on the qualitative aspects of interfacial and mechanical stability. However, quantitative results to determine how these proposed strategies can influence the Li inventory losses have yet to be revealed.

Our earlier work on silicon thin film anodes using TGC method quantitatively confirmed the trapped Li—Si alloy formation due to high volume expansion-contraction cycles. In this work, the TGC method has been successfully implemented to μSi electrode, which contained both binder and carbon conductive agent. The SEI formation process at the first cycle was quantitatively studied with the evolution of SEI and trapped Li—Si amount upon cycling in half cells and full cells when using different binders. It was also identified that employing the SoC control by increasing the N/P ratio in the full cell can reduce the trapped Li—Si when using CMC-Na as the binder. Also, the trapped Li—Si amount was drastically reduced when PAA was used as the anode binder. The TGC method allows us to quantitatively distinguish the loss of active lithium consumed by SEI formation and the trapped Li—Si alloy caused by the kinetic limitations and contact losses.

Methods

Sample Preparation. The anodes consisted of commercial μSi (1-5 μm, Alfa Aesar) or Nano Si (<50 nm, Alfa Aesar) as the active material (70% by weight), Acetylene carbon black (AB, Strem Chemicals) as a conductive additive (20% by weight), and CMC-Na (Mw 250,000, Sigma Aldrich) or PAA (Mv 450,000, Sigma Aldrich) as binders (10% by weight). The electrode cast mixture was dispersed in water and then mixed using a Thinky Mixer at 2000 rpm for 40 min. The obtained slurry was cast onto a copper foil using Doctor blade and was dried for 12 h at 80° C. under vacuum to remove the water. After the cast was dried, electrodes with varying diameters, ⅜ inch for half-cell and 13 mm for the full cell, were punched from the casts. The LiFePO4 (LFP) cathode for the full cell was purchased from NEI (Areal capacity ˜1.25 mAh/cm², diameter ½ inch). For the N/P ratio control study, μSi anode cast with different areal loading: 1.9 mAh/cm², 2.5 mAh/cm², 3.1 mAh/cm², 3.8 mAh/cm² were cast onto the copper foil.

Electrochemical test. For the half-cell testing, the μSi electrode or Nano Si electrode was assembled into a 2032 type coin cell. Li metal (1 mm thick) was employed as the counter electrode. The electrolyte was 1 mol/L LiPF6 dissolved in EC:diethyl carbonate (DEC) (1:1 by weight) with 10% FEC (Gotion). The half-cell was cycled between 50 mV and 1.5 V at room temperature at a current density (1C=3500 mA/g) of C/20 during the first cycle and C/10 for subsequent cycles. For the full-cell testing, the μSi electrode was paired with an LFP cathode and assembled in a 2032 type coin cell. The full cell was cycled between 2 V and 3.6 V at room temperature at a current density (1C=170 mAh/g, based on LFP) of C/10 for the first two cycles and C/3 for the subsequent cycles. All the coin cells were assembled in the Ar-filled glovebox and tested on the NeWare battery cycler.

Characterizations.

TGC: The TGC experiments were performed using a Shimadzu GC-2010 Plus Tracera equipped with a BID detector. The Split temperature was kept at 200° C. with a split ratio of 2.5 (split vent flow: 20.58 ml/min, column gas flow: 8.22 ml/min, purge flow: 0.5 ml/min). Column temperature (RT-Msieve 5A, 0.53 mm) was kept at 40° C., and the BID detector was held at 235° C. Helium (99.9999%) was used as the carrier gas, and the BID detector gas flow rate was 50 ml/min. The electrode sample was put in a septum sealed glass vial. After injecting the 0.5 mL ethanol (200 proof anhydrous), the sample gases (30 μL) were injected into the machine via a 50 μL Gastight Hamilton syringe.

Scanning Electron Microscopy (SEM): The SEM was conducted on the FEI Apreo SEM; the coin cells were disassembled in the Ar-filled glovebox after cycling. The samples were transferred to the SEM chamber for cross-section analysis with minimal exposure to air. The electron beam operating voltage was 5 kV, and the operating current was 0.1 nA.

180° Peel-off Test: 180° Peel-off Test was performed using Instron Load Frame B. The two binder casts—PAA and CMC-Na were prepared at high mass loading (5.5 mAh/cm²) with the same weight percentage of active material, conducting agent, and binder (70:20:10) used for the electrochemical tests. Before the test, the two casts were cut into 30 mm wide, 70 mm long specimens. The thickness of the specimen was 55 μm. The Kapton® tape was then attached to the specimen. This tape was peeled off using the Instron Load Frame B mechanical testing machine. The cross-head speed used for the test was 200 mm/min. During the peel-off process, a load v/s displacement plot was recorded to determine the adhesion strength of the binder to the copper current collector.

XPS: XPS was performed using a Kratos AXIS Supra. All samples were prepared without washing while transferred without air exposure. An Al anode source at 15 kV with a 10-8 Torr vacuum level was applied for measurement. The step size for Survey scans was 1.0 eV, followed by high-resolution scans with a step size of 0.1 eV. C 1s peak at 284.6 eV was used for calibration. The etching condition used was Ar+mono mode, 5 keV voltage.

Results and Discussion

Establishing TGC method for μSi electrodes. To ensure that results generated from the quantification study are valid, several control experiments were performed to verify ethanol as a suitable solvent for the TGC study. Our previous work demonstrated that ethanol could be used as the titrant for the silicon thin film in the TGC study. However, the reactivity of conducting agent and binder with ethanol has yet to be verified. Half cells were first assembled using electrodes with CMC-Na binder and CMC-Na with AB. The μSi electrode was also tested as the reference here. The half cells were discharged to 0.01 V with a current density of 0.1 mA/cm² and then disassembled to perform the TGC test. From the TGC data, H₂ gas was not detected from the binder-only electrode, indicating that CMC-Na would not produce any H₂ gas with ethanol. While some H₂ gas was detected from the CMC-Na+AB electrode, this was 2 orders of magnitude lower than the expected amount from the μSi electrode. Furthermore, CMC-Na+AB after 1 cycle was verified with the TGC titrant. In the case of μSi electrode, a large amount of H₂ gas was detected due to the presence of the Li—Si alloy formed during lithiation of Thus, it can be concluded that most H₂ gas detected in the μSi electrode should come from the Li—Si alloy, according to equation (1) below. The H₂ amount can be quantified by the GC machine based on the calibration curve we built in our previous work. Therefore, the SEI amount can be obtained based on equation (2).

2LixSi(s)+2xH+(aq.)=2xLi+(aq.)+2Si(s)+xH₂(g) (1)

Li loss (from cycler)=Trapped Li—Si alloy (from GC)+SEI Li+ (2)

Quantifying Li—Si Alloy & SEI Growth.

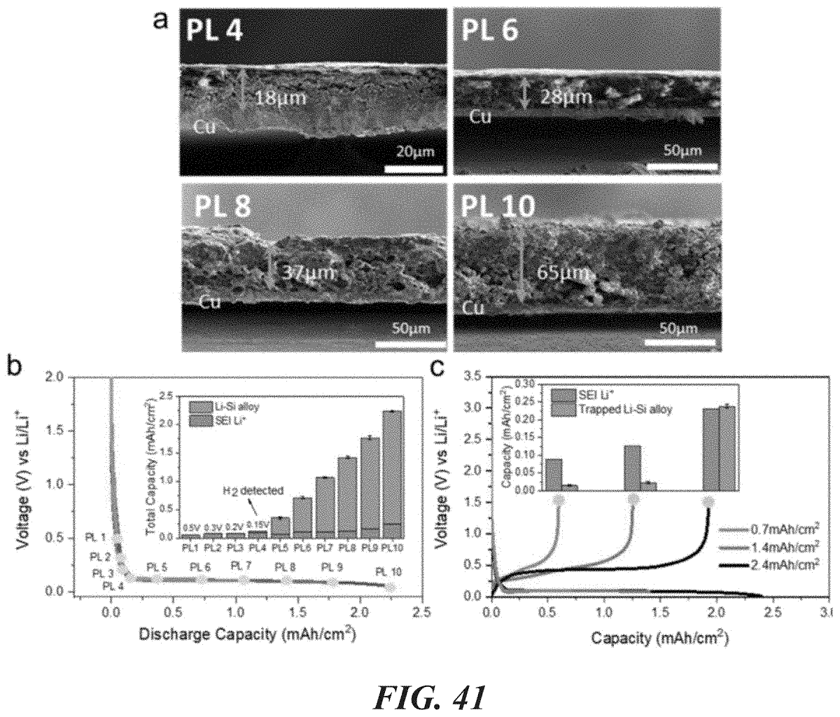

To study the evolution of Li—Si alloy and SEI formation, TGC was performed at different lithiation states (PLX, where X=1, 2, 3 . . . ) by controlling the cut-off capacity for the μSi electrode, and the results are shown in FIG. 41b. It is worth noting that no H₂ gas could be detected until 0.15 V (corresponds to PL4), indicating that the initial capacity fully corresponds to only SEI formation. This result also indicates that the alloying reaction commenced when the voltage (vs. Li/Li+) reached between 0.2 V and 0.15 V (corresponds to PL4 and PL3, respectively). Upon analyzing the SEM images of the cross-section (FIG. 41a), it can be seen that the electrode is expanding non-linearly with respect to lithiation capacity from PL4 till the end of lithiation at PL10. Additionally, TGC results from PL4 to PL10 (FIG. 41b-inset) show that SEI is increasing with further lithiation, with the largest increase at PL9 & 10. As the rate of SEI formation is correlated with any new surfaces being formed, this indicates a non-linear volume expansion of the electrode during lithiation. As the largest degree of volume change occurs toward the end of lithiation (PL9 & 10), it can be inferred that most capacity losses would occur within these regions. To verify this, a control experiment was set up to understand the impact of non-linear volume change on irreversible capacity loss. The half cells were cycled for one cycle with 3 different lithiation capacities: 0.7 mAh/cm², 1.4 mAh/cm² and 2.4 mAh/cm². From the electrochemical data as shown in FIG. 41c, it can be seen that the initial coulombic efficiency (ICE) was lowest for the cell with a lithiation capacity of 2.4 mAh/cm², which was 80.42%, and highest for the cell with lithiation capacity of 0.7 mAh/cm² which was 85.16%. Moreover, from FIG. 41c-inset, the trapped Li—Si, and SEI were lowest for the cell with a lithiation capacity of 0.7 mAh/cm² and highest for the cell with a lithiation capacity of 2.4 mAh/cm². Therefore, this result shows that the irreversible Li inventory loss can be reduced if the regions of largest volume expansion in μSi electrodes can be avoided.

Binder and Active Material Particle Size Effects on Li Inventory Losses.

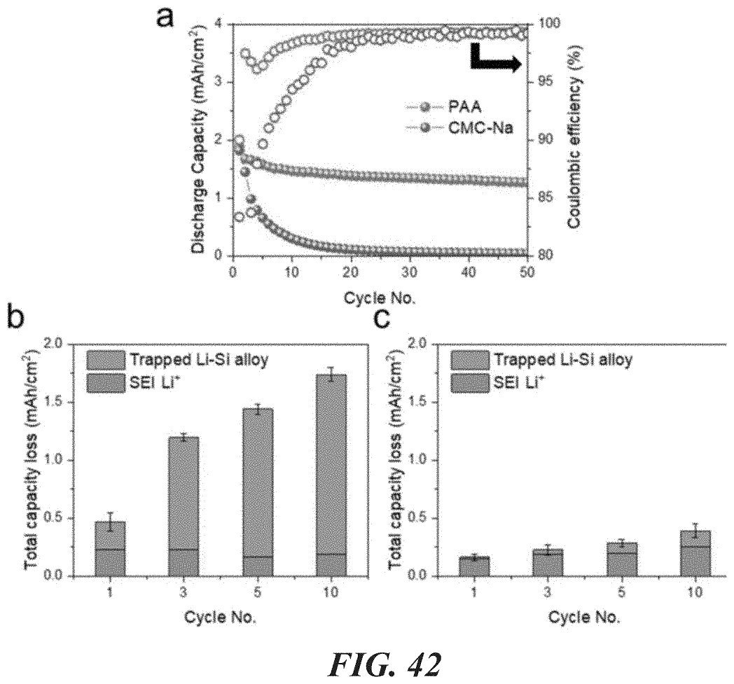

As robust binders are commonly proposed as a solution to mitigate capacity losses, the TGC tool was also applied to analyze the effects of two commonly used binders in electrodes: PAA and CMC-Na. From the cycle performance of CMC-Na half-cell and PAA half-cell in FIG. 42a, it can be seen that the capacity retention was only 4.5% for CMC-Na half-cell after 50 cycles. In contrast, in the case of PAA half-cell, the capacity retention was 76.6% after 50 cycles. Also, the average CE over 50 cycles for CMC-Na half-cell and PAA half-cell were 97.2% and 98.8% respectively. From the TGC data in FIGS. 42b, c, it is seen that both cells exhibited a similar degree of SEI formation. However, the total capacity loss of CMC-Na half-cell is higher than that of PAA half-cell at every cycle, mainly attributed to accumulation of trapped Li—Si alloy. The binder effect on SEI was further studied using XPS depth profiling (FIGS. S4 and S5). From the XPS depth profiling data, it can be observed that LiF in the F 1s spectrum was seen at the surface (0 min) and also after 2 min of etching for PAA and CMC-Na binders. Also, the other inorganic species: Li2O was seen on the surface and also after 2 min of etching which was confirmed from O 1s spectra and Li 1s spectra. Similar observations can be seen for O 1s spectra, Li is spectra and C is spectra regarding the carbonaceous species such as ROLi (corresponding to 531 eV in O 1s and 55 eV in Li 1s), C—O (corresponding to 530 eV in O 1s and 287 eV in C 1s), C—O (corresponding to 286 eV in C 1s and 532 eV in O 1s), C—C (corresponding to 285 eV in C 1s), consistent with earlier study of SEI components on Nano Si anode, suggesting a mixed organic and inorganic SEI of similar compositions in PAA and CMC-Na binders. Thus, it can be inferred that the capacity losses due to SEI are not affected by the type of binder used. Conversely, the degree of trapped Li—Si alloy in the half cells for the extended cycles is highly influenced by the type of binder used. Particle size reduction is a commonly proposed strategy to mitigate capacity losses. To test the impact of active material particle size on Lithium inventory losses, the TGC tool was used in Nano Si half-cell with CMC-Na and PAA binders after 1 cycle and 5 cycles. From the TGC data, it can be seen that for Nano Si with PAA and CMC-Na binders, the trapped Li—Si alloy were 3.08% and 19.05% of the total loss respectively after 1st cycle and 12.74% and 23.07% of the total loss respectively after 5 cycles. However, in the case of pSi with PAA and CMC-Na binders, the trapped Li—Si alloy were 6.81% and 50.74% of the total loss respectively after 1st cycle and 30.33% and 88.26% of the total loss after 5 cycles. The results indicate that trapped Li—Si alloy formation can be further decreased by reducing the particle size of the active material (Si). Many works in the literature have reported that reducing the particle size can increase the density of grain boundaries, improving the Li diffusion kinetics and decreasing the ionic and electronic transport distances. This can decrease the trapped Li—Si alloy formation at the particle level which is in agreement with our TGC results.

SoC Effects on Li Inventory Losses.

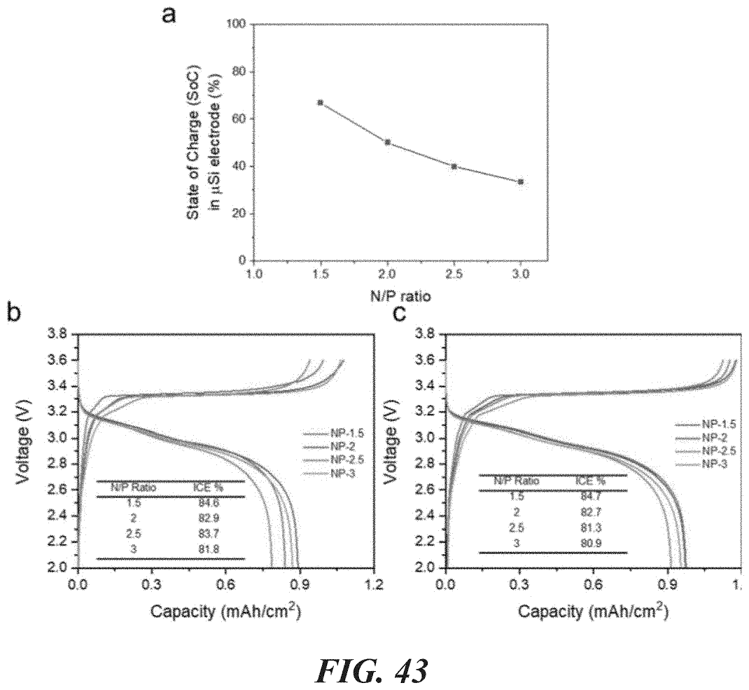

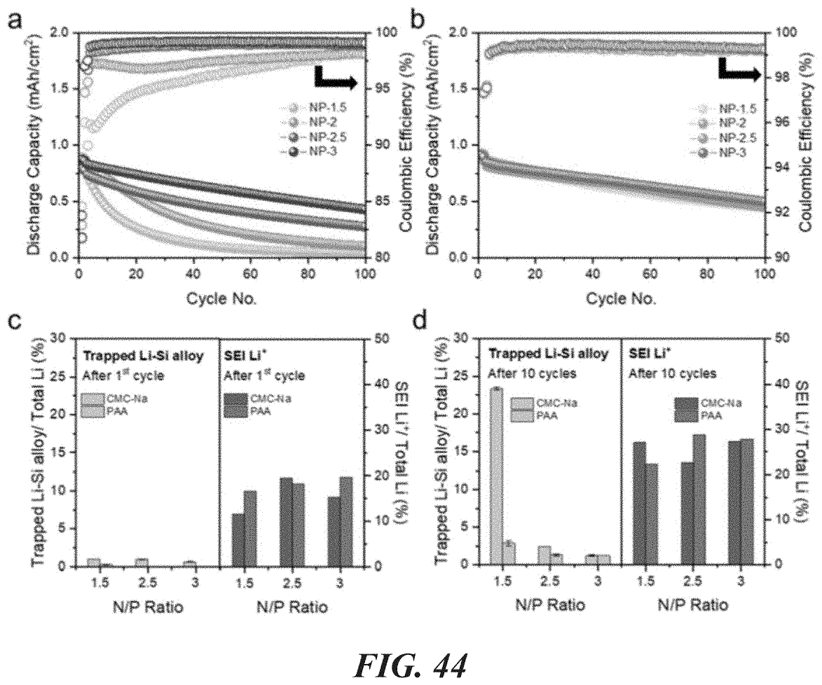

As previously described, the regions where high-volume expansion of pSi occurs should be avoided to limit the amount of trapped Li—Si and SEI formed. This can be achieved by SoC control as the SoC is correlated to the total amount of Li present in the silicon. As SoC control via voltage cutoff is difficult in half cells due to the flat voltage profile of the pSi electrode, full cells with different N/P ratios were assembled to control the SoC. By increasing N/P ratio from 1.5 to 3, the total amount of Li in pSi electrode decreases from 66.67% to 33.33%, as shown in FIG. 43a, limits the overall volume expansion of the pSi electrode upon cycling. In this case, both CMC-Na and PAA binders were also used for comparison, and the data are shown in FIGS. 43b, c. For pSi-CMC-Na//LFP full cells, it can be seen in FIG. 43b that for the N/P ratios 1.5, 2, 2.5, and 3, the ICEs measured were 84.6%, 82.9%, 83.7%, and 81.8%, respectively. As for the cycling performance in FIG. 44a, CMC-Na cells using 1.5, 2, 2.5, and 3 as the N/P ratios show the capacity retention 6.9%, 17.2%, 44.8% and 59.7% respectively after 80 cycles and the average CE was 95.6%, 97.3%, 98.8%, 99.1% respectively. However, when the binder was changed to PAA, as shown in FIG. 43c, it can be seen that for the N/P ratios: 1.5, 2, 2.5, and 3, the ICE was 84.7%, 82.7%, 81.3%, and 80.9% respectively and from FIG. 44b, the capacity retention was 56.9%, 59.7%, 66.6%, 66.6% respectively after 80 cycles and the average CE was 99.2%, 99.3%, 99.4%, 99.4% respectively after 80 cycles. It is worth noting that the average CE still does not reach 99.9% after the improvement, which indicates that other modification methods such as electrolyte or prelithiation need to be further optimized for pSi electrode. All these data sets pointed out that controlling the volume expansion for pSi electrodes is vital toward mitigating trapped Li—Si accumulation in full cells.

TGC tests were further conducted on anodes with different N/P ratios after the 1st and 10th cycles, and the corresponding data are shown in FIGS. 44c, d. The trapped Li—Si alloy and SEI Li amount here are calculated based on the first charge capacity of the full cell, which is defined as the total Li amount in a full cell with no lithium excess. It shows that SEI was the leading cause of Li inventory loss in full cells at the 1st cycle for CMC-Na and PAA cells that occupied more than 11% of the Li inventory loss, whereas trapped Li—Si amount was negligible (less than 1%). All cells displayed increased Li inventory losses after 10 cycles, with the greatest trapped Li—Si amounts seen in CMC-Na cells, which accounted for more than 23% capacity loss for cell with N/P=1.5. However, the trapped Li—Si was found to be less than 1.5% when the N/P ratio was increased to 3. Meanwhile, SEI was the primary reason for capacity failure in PAA cells, as trapped Li—Si was significantly lower with less than 3% even for N/P=1.5. The reduction in trapped Li—Si when N/P ratio was increased from 1.5 to 3 for CMC-Na binder was due to the mild volume expansion-contraction in the pSi anode caused by reduction in SoC from 66.67% to 33.33%. This was analogous to the lithiation capacity control study in pSi-CMC-Na half cells discussed previously (FIG. 41c). The surface SEM image of pSi anodes for N/P=1.5 and 3 with CMC-Na binder after 20 cycles reveals that cracks are observed on pSi-CMC-Na anode from N/P=1.5 full cell and cracks are absent on pSi-CMC-Na anode from N/P=3 full cell. The results further confirm that severe volume expansion-contraction damages the pSi-CMC-Na anode from N/P=1.5 full cell, potentially leading to electrical isolation and increased trapped Li—Si alloy. Based on these TGC results, the PAA binder can reduce generation and accumulation of trapped Li—Si compared to CMC-Na.

To further investigate the large disparities between CMC-Na and PAA, a 180° peel-off test was performed to compare their binding strengths respectively. It can be observed that the average load experienced by the PAA electrode was 2.89 N for a displacement range of 50 mm. In contrast, the average load experienced by the CMC-Na electrode was only 0.68 N. Moreover, very little electrode material was peeled off from the copper current collector in the case of the PAA electrode, compared to the CMC-Na electrode, even with a higher average load of 2.89 N. From the test results, it can be inferred that the PAA electrode has higher adhesion strength than the CMC-Na electrode. Thus, the PAA binder binds the active material and conducting agent with current collector more effectively than the CMC-Na binder, resulting in less trapped Li—Si.

This study quantitatively analyzed the effect of the SoC control and type of binder on reducing the Li inventory losses in pSi anodes. It showed that trapped Li—Si was the primary cause for Li inventory loss, a result of electronic isolation of active materials during severe volume change in the electrode. This trapped Li—Si accumulation can be mitigated when PAA binder is used instead of CMC-Na. Additionally, SoC control was shown to improve capacity loss by avoiding regions of large volume expansion experienced in the electrode. In the full cell, this was achieved by controlling the N/P ratio. While this quantification study shines light on the root causes of capacity fade with respect to trapped Li—Si or SEI formation, and how it can be mitigated with robust binders and SoC control, full cells with no lithium excess still show significant capacity fade especially over 100 cell cycles. To enable pSi electrodes in practical LIBs, alternative strategies must still be developed to reduce or completely eliminate these effects over extended cell cycling.

### CONCLUSIONS

In conclusion, Trapped Li—Si and SEI were quantified in pSi anode using the TGC in both half-cell and full cell systems. It was found that SEI formation occurs at the onset of lithiation (until 0.15 V), only after which does the formation of Li—Si alloy occur. Non-linear volume expansion of the pSi anode was observed using both SEM imaging as well as the TGC method, which leads to an increase in rate of SEI formation at regions of high-volume expansion. The quantification results for pSi anode half-cells and full cells showed that trapped Li—Si is the primary reason for the capacity fade, and that it can be mitigated if PAA binder is used instead of CMC-Na. By tuning N/P ratios in full cells, SoC control can be achieved to reduce Li inventory losses. A significant decrease in trapped Li—Si over extended cycling was observed when the N/P ratio increased from 1.5 to 3 in the case of full cells with CMC-Na binder. The results in this work demonstrate the capability of the TGC quantification tool to analyze Li inventory losses in μSi anodes, and serves as validation for TGC method applications in other alloy-based anode systems.

### EXAMPLE EMBODIMENTS

In some embodiments, the techniques described herein relate to a method for quantifying an amount of metallic substance (M⁰) in an anode material, including: sealing a sample in a container, the sample including the anode material; injecting an amount of a protic titrant into the container to react with the sample; agitating the container; implementing a titration-gas chromatography (TGC) on the sample to detect an amount of hydrogen gas (H₂) released from a reaction between the titrant and the sample, where: a reduced M⁰ reacts with the titrant to produce the H₂; and converting the detected amount of H₂ to the amount of M⁰.

In some embodiments, the techniques described herein relate to a method, where the container is located within an Argon gas-filled glovebox or a dry room.

In some embodiments, the techniques described herein relate to a method, where the agitating includes shaking the container.

In some embodiments, the techniques described herein relate to a method further including: connecting the container to a sample injector equipped with a flow controller.

In some embodiments, the techniques described herein relate to a method, where the implementing the TGC includes using a H₂ detector for detection of the released hydrogen gas.

In some embodiments, the techniques described herein relate to a method, where the converting the detected H₂ amount to the M⁰ amount includes using a calibration curve.

In some embodiments, the techniques described herein relate to a method, where the anode material is usable in rechargeable batteries, and the sample includes an alkaline metal anode material, an alloy type anode material, a carbon-based anode material, a composite anode material, or a multivalent anode material.

In some embodiments, the techniques described herein relate to a method, where the anode material is usable in lithium-ion batteries, and the sample includes LiₓC₆, LiₓSi, or LiₓSn.

In some embodiments, the techniques described herein relate to a method, where the sample includes organic or inorganic Mn⁺ compositions and the method is configured to differentiate an amount of M⁰ from the organic or inorganic Mn⁺ compositions based on the released H₂ gas.

In some embodiments, the techniques described herein relate to a method, where the titrant is selected from water, methanol, ethanol, and an acid.

In some embodiments, the techniques described herein relate to a method, where the M0 includes Li, Na, K, Mg, Ca, Fe, Zn, or Al.

In some embodiments, the techniques described herein relate to a method, where the amount of M⁰ quantified from the sample is less than 5 micrograms.

In some embodiments, the techniques described herein relate to a method, where the amount of M⁰ quantified from the sample is less than 1 microgram.

In some embodiments, the techniques described herein relate to a method, where the M0 is Li⁰ and the titrant is water.

In some embodiments, the techniques described herein relate to a method, where the M⁰ is Si in a Li—Si alloy and the titrant is ethanol.

In some embodiments, the techniques described herein relate to a method, where the M0 is Li in a LixC₆ composition and the titrant is ethanol, water or sulfuric acid.

In some embodiments, the techniques described herein relate to a system for quantifying an amount of metallic substance (M⁰) in an anode material based on titration-gas chromatography (TGC). The system includes a sealable sample container configured to hold a sample including the anode material and an amount of a protic titrant. The sample container is configured to receive the amount of the protic titrant by injection, and to allow production of hydrogen gas (H₂) upon reaction of a reduced M⁰ in the anode material with the protic titrant. The system also includes a gas chromatography (GC) device fluidically coupled with the sample container. The GC device is configured to detect the H₂ released from the reaction between the protic titrant and the reduced M⁰ in the sample container, and to enable the detected amount of H2 to be converted to the amount of M⁰.

In some embodiments, the techniques described herein relate to a system, further including an argon gas-filled glovebox, where the sample container and the GC device are positioned within the Argon gas-filled glovebox.

In some embodiments, the techniques described herein relate to a system, further containing a sample injector equipped with a flow controller for injecting the released hydrogen into the GC device.

In some embodiments, the techniques described herein relate to a system, where the sample container is configured to receive the amount of the titrant by injection by a titration pipette or burette.

### REMARKS

In some embodiments, the present technology can include data processing techniques implemented on a data processing system. Implementations of such aspects of the present technology and/or other computer-based functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for quantifying an amount of metallic substance (M⁰) in an anode material, comprising:
sealing a sample in a container, the sample comprising the anode material;
injecting an amount of a protic titrant into the container to react with the sample;
agitating the container;
implementing a titration-gas chromatography (TGC) on the sample to detect an amount of hydrogen gas (H₂) released from a reaction between the titrant and the sample, wherein:
a reduced M⁰ reacts with the titrant to produce the H₂; and
converting the detected amount of H₂ to the amount of M⁰.

2. The method of claim 1, wherein the container is located within an Argon gas-filled glovebox or a dry room.

3. The method of claim 1, wherein the agitating includes shaking the container.

4. The method of claim 1 further comprising:
connecting the container to a sample injector equipped with a flow controller.

5. The method of claim 1, wherein the implementing the TGC includes using a H₂ detector for detection of the released hydrogen gas.

6. The method of claim 1, wherein the converting the detected H₂ amount to the M⁰ amount includes using a calibration curve.

7. The method of claim 1, wherein the anode material is usable in rechargeable batteries, and the sample includes an alkaline metal anode material, an alloy type anode material, a carbon-based anode material, a composite anode material, or a multivalent anode material.

8. The method of claim 1, wherein the anode material is usable in lithium-ion batteries, and the sample includes LiₓC₆, LiₓSi, or LiₓSn.

9. The method of claim 1, wherein the sample includes organic or inorganic Mⁿ⁺ compositions and the method is configured to differentiate an amount of M⁰ from the organic or inorganic Mⁿ⁺ compositions based on the released H₂ gas.

10. The method of claim 1, wherein the titrant is selected from water, methanol, ethanol, and an acid.

11. The method of claim 1, wherein the M⁰ includes Li, Na, K, Mg, Ca, Fe, Zn, or Al.

12. The method of claim 1, wherein the amount of M⁰ quantified from the sample is less than 5 micrograms.

13. The method of claim 12, wherein the amount of M⁰ quantified from the sample is less than 1 microgram.

14. The method of claim 1, wherein the M⁰ is Li⁰ and the titrant is water.

15. The method of claim 1, wherein the M⁰ is Si in a Li—Si alloy and the titrant is ethanol.

16. The method of claim 1, wherein the M⁰ is Li in a LiₓC₆ composition and the titrant is ethanol, water or sulfuric acid.

17. A system for quantifying an amount of metallic substance (M⁰) in an anode material based on titration-gas chromatography (TGC), the system comprising:
a sealable sample container configured to hold a sample comprising the anode material and an amount of a protic titrant, the sample container is configured to receive the amount of the protic titrant by injection, and to allow production of hydrogen gas (H₂) upon reaction of a reduced M⁰ in the anode material with the protic titrant; and
a gas chromatography (GC) device fluidically coupled with the sample container, wherein:
the GC device is configured to detect the H₂ released from the reaction between the protic titrant and the reduced M⁰ in the sample container, and to enable the detected amount of H₂ to be converted to the amount of M⁰.

18. The system of claim 17, further comprising an argon gas-filled glovebox, wherein the sample container and the GC device are positioned within the Argon gas-filled glovebox.

19. The system of claim 17, further containing a sample injector equipped with a flow controller for injecting the released hydrogen into the GC device.

20. The system of claim 17, wherein the sample container is configured to receive the amount of the titrant by injection by a titration pipette or burette.
